(19) United States
(12) Patent Application Publication
(10) Pub. No.: US 2026/0143249 A1
(43) Pub. Date: May 21, 2026

(54) PHOTODETECTION ELEMENT AND ELECTRONIC DEVICE

(71) Applicant: SONY SEMICONDUCTOR SOLUTIONS CORPORATION, KANAGAWA (JP)

(72) Inventor: Takuya UEHARA, KANAGAWA (JP)

(21) Appl. No.: 19/114,476

(22) PCT Filed: Sep. 5, 2023
(86) PCT No.: PCT/JP2023/032304

§ 371 Date: Mar. 24, 2025

(30) Foreign Application Priority Data
Sep. 30, 2022 (JP) 2022-158816

(51) Int. Cl. H04N 25/47; G01J 1/44; H04N 25/709

(52) U.S. Cl. CPC H04N 25/47; G01J 1/44; H04N 25/709

(57) ABSTRACT

To reduce detection of a noise event and to quickly and accurately detect an event. A photodetection element includes: a first pixel region including a plurality of first pixels each performing detection of an event based on an amount of change of an amount of incident light; and a second pixel region disposed in the vicinity of the first pixel region and including a second pixel that performs detection of the event around a first pixel in which the event is detected among the plurality of first pixels.

### TECHNICAL FIELD

The present disclosure relates to a photodetection element and an electronic device.

### BACKGROUND ART

An event-based vision sensor (EVS) has been proposed that acquires only data of a photoelectric conversion element in which some event such as a luminance change has occurred in an imaging scene at high speed. The EVS performs an operation of detecting a luminance change of light as an event. As a problem of the EVS, detection of a noise event is known. The noise event refers to an event that is erroneously detected although no event has actually occurred. Patent Document 1 discloses that a noise event is detected by oscillation of a voltage signal output from a current-voltage conversion circuit in an event detection circuit. In Patent Document 1, detection of a noise event caused by the oscillation of the voltage signal is reduced by connection of a capacitor that compensates for a phase delay of the voltage signal to the current-voltage conversion circuit.

### CITATION LIST

### Patent Document

### Patent Document 1: WO 2019/087472 A

### SUMMARY OF THE INVENTION

### Problems to be Solved by the Invention

The noise event may occur due to various factors other than the oscillation of the voltage signal output from the current-voltage conversion circuit. However, Patent Document 1 does not take measures to reduce detection of a noise event that occurs due to a factor other than the oscillation of the voltage signal.

The EVS generally performs detection of an event in units of pixels of a pixel array unit. Since the noise event may occur at a random pixel position of the pixel array unit, some measure needs to be taken with all the pixels of the pixel array unit in mind in order to reduce detection of the noise event. As a measure for the noise event, for example, it is conceivable to detect the event with only some pixels simply thinned out from the pixel array unit, but it takes time to perform processing of thinning out the pixels, and the resolution of an event detection image decreases.

Thus, the present disclosure provides a photodetection element and an electronic device capable of quickly and accurately detecting a true event without reducing the resolution of an event detection image while reducing detection of a noise event occurring due to various factors.

### Solutions to Problems

In order to solve the above problem, according to the present disclosure, provided is a photodetection element including:
a first pixel region including a plurality of first pixels each performing detection of an event based on an amount of change of an amount of incident light; and
a second pixel region disposed in the vicinity of the first pixel region and including a second pixel that performs detection of the event around a first pixel in which the event is detected among the plurality of first pixels.

One or more of the second pixels in the second pixel region may be associated with one of the first pixels in the first pixel region, and
detection of the event may be performed in all of the second pixels corresponding to the first pixel in which the event is detected.

The plurality of first pixels in the first pixel region may be disposed apart from each other with a pixel other than the first pixel interposed therebetween in a first direction and a second direction intersecting each other.

The pixel other than the first pixel may include the second pixel.

The plurality of first pixels in the first pixel region may be disposed in a first annular pixel region extending in a first direction and a second direction intersecting each other.

There may be included a pixel array unit including the first pixel region and the second pixel region and extending in the first direction and the second direction, and
the first annular pixel region may be disposed on an outer peripheral side of the pixel array unit.

The second pixel in the second pixel region may be disposed on an inner side from the first annular pixel region in the pixel array unit.

The second pixel in the second pixel region may be disposed in a second annular pixel region on an inner side from the first annular pixel region in the pixel array unit.

There may be included a third annular pixel region that is disposed on a further inner side from the second annular pixel region of the pixel array unit and in which two or more of the first pixels are disposed.

There may be included a pixel array unit including the first pixel region and the second pixel region and extending in the first direction and the second direction, and
the plurality of first pixels in the first pixel region may be disposed along a plurality of lines extending in the first direction or the second direction.

The second pixel in the second pixel region may be disposed between the plurality of lines along a direction in which the plurality of lines extends.

There may be included a third pixel region disposed in the vicinity of the second pixel region and including a third pixel that performs detection of the event around the second pixel in which the event is detected.

A size of the first pixel may be larger than a size of the second pixel.

The first pixel may include
a first photoelectric conversion element that accumulates charges corresponding to an amount of incident light, and
a first pixel circuit that detects the event on the basis of the charges,
the first pixel circuit may include a first control signal generator that outputs a first control signal of predetermined logic separately from a detection signal of the event when the event is detected, and
the second pixel may include
a second photoelectric conversion element that accumulates charges corresponding to an amount of incident light, and
a second pixel circuit that detects the event on the basis of the charges accumulated in the second photoelectric conversion element only when the first control signal in the first pixel corresponding to the second pixel is the predetermined logic.

The second pixel circuit may include:
a charge-voltage conversion circuit that converts the charges accumulated in the second photoelectric conversion element into a voltage;
a differentiation circuit that generates a differential signal corresponding to a change in the voltage converted by the charge-voltage conversion circuit; and
a quantizer that generates a detection signal of the event on the basis of a result of performing a comparison operation of comparing a signal level of the differential signal with a threshold, and
the quantizer may perform the comparison operation only when the first control signal in the first pixel corresponding to the second pixel has the predetermined logic.

There may be included a threshold control unit that controls a voltage level of the threshold in accordance with at least one of the number of the first pixels in which the event is detected among a plurality of the first pixels and the number of the second pixels in which the event is detected among a plurality of the second pixels.

The first pixel circuit may output a first event in which a change from a low state to a high state of an amount of incident light is detected or a second event in which a change from a high state to a low state of an amount of incident light is detected, and
the first control signal generator may set the first control signal to the predetermined logic when the first event or the second event is output from the first pixel circuit.

The first pixel circuit may include a pixel operation switcher that causes the first control signal generator to output the first control signal of the predetermined logic regardless of whether or not the event is detected in the first pixel circuit, or causes the first control signal generator to output the first control signal of the predetermined logic only when the event is detected in the first pixel circuit.

Each of pixels in the pixel array unit may include, with a pixel group including two or more pixels in the pixel array unit as a unit, a pixel operation switcher to cause any one pixel in the pixel group to be the first pixel and remaining pixels to be the second pixel.

Furthermore, according to the present disclosure, provided is an electronic device including:
a photodetection element that outputs image data; and
a recording unit that records the image data, in which
the photodetection element includes:
a first pixel region including a plurality of first pixels each performing detection of an event based on an amount of change of an amount of incident light; and
a second pixel region disposed in the vicinity of the first pixel region and including a second pixel that performs detection of the event around a first pixel in which the event is detected among the plurality of first pixels.

### BRIEF DESCRIPTION OF DRAWINGS

FIG. 1 is a block diagram of an electronic device in a first embodiment of the present disclosure.

FIG. 2 is a diagram illustrating an example of a stacked structure of a photodetection element.

FIG. 3 is a plan view illustrating an example of a light receiving chip.

FIG. 4 is a plan view illustrating an example of a detection chip.

FIG. 5A is a circuit diagram illustrating a first example of a pixel.

FIG. 5B is a circuit diagram illustrating a second example of the pixel.

FIG. 6 is a graph illustrating a change in a current flowing through an input node of a differentiation circuit.

FIG. 7 is a graph illustrating a change in an output voltage of the differentiation circuit.

FIG. 8 is a diagram illustrating an example of occurrence of a noise event in a pixel array unit.

FIG. 9 is a plan view of the pixel array unit in the first embodiment of the present disclosure.

FIG. 10 is a block diagram of a first pixel and a second pixel in the first embodiment of the present disclosure.

FIG. 11A is a circuit diagram illustrating a first example of a first control signal generator, a first quantizer, and a second quantizer in the first embodiment of the present disclosure.

FIG. 11B is a circuit diagram illustrating a second example of a first control signal generator, a first quantizer, and a second quantizer in the first embodiment of the present disclosure.

FIG. 12 is a circuit diagram illustrating an example in which the first quantizer in one first pixel is connected to a plurality of the second quantizers in a plurality of second pixels via the first control signal generator.

FIG. 13 is a flowchart illustrating an event detection operation of the photodetection element in the first embodiment of the present disclosure.

FIG. 14 is a plan view illustrating an example of event detection in the pixel array unit.

FIG. 15A is a plan view illustrating an example in which the noise event occurs in some pixels in the pixel array unit in the first embodiment of the present disclosure.

FIG. 15B is a plan view illustrating an example in which some of the first pixels detect the noise event in the pixel array unit in the first embodiment of the present disclosure.

FIG. 16A is a plan view illustrating a first example of a pixel array unit in a second embodiment of the present disclosure.

FIG. 16B is a plan view illustrating a second example of a pixel array unit in the second embodiment of the present disclosure.

FIG. 17 is a plan view of a pixel array unit in a third embodiment of the present disclosure.

FIG. 18 is a plan view of a pixel array unit in a fourth embodiment of the present disclosure.

FIG. 19 is a block diagram illustrating an internal configuration of the first pixel, the second pixel, and a third pixel in the fourth embodiment of the present disclosure.

FIG. 20 is a circuit diagram of the first control signal generator, a second control signal generator, the first quantizer, the second quantizer, and a third quantizer in the fourth embodiment of the present disclosure.

FIG. 21 is a plan view of a pixel array unit in a fifth embodiment of the present disclosure.

FIG. 22 is a circuit diagram illustrating a part of an internal configuration of the first pixel, a normal pixel, and the second pixel in the fifth embodiment of the present disclosure.

FIG. 23 is a plan view of a pixel array unit in a sixth embodiment of the present disclosure.

FIG. 24 is a block diagram illustrating a schematic configuration of a photodetection element in a seventh embodiment of the present disclosure.

FIG. 25 is a block diagram of the first pixel and the second pixel in an eighth embodiment of the present disclosure.

FIG. 26A is a circuit diagram of the first control signal generator, a pixel operation switcher in an off state, the first quantizer, and the second quantizer in the eighth embodiment of the present disclosure.

FIG. 26B is a circuit diagram of the first control signal generator, the pixel operation switcher in an on state, the first quantizer, and the second quantizer in the eighth embodiment of the present disclosure.

FIG. 27A is a diagram illustrating a first example in which one of four pixels is set as the first pixel and remaining pixels are set as the second pixels.

FIG. 27B is a diagram illustrating a second example in which one of the four pixels is set as the first pixel and the remaining pixels are set as the second pixels.

FIG. 28 is a block diagram of two pixels included in one pixel group in a ninth embodiment of the present disclosure.

FIG. 29A is a circuit diagram of a first example of a quantizer, a pixel operation switcher, and a control signal generator in two pixels in a case where one of the two pixels included in one pixel group is operated as the first pixel and the other is operated as the second pixel.

FIG. 29B is a circuit diagram of a second example of the quantizer, the pixel operation switcher, and the control signal generator in two pixels in a case where one of the two pixels included in one pixel group is operated as the first pixel and the other is operated as the second pixel.

FIG. 30 is a detailed circuit diagram of four quantizers, pixel operation switchers, and control signal generators included in one pixel group.

FIG. 31 is a block diagram illustrating an example of a schematic configuration of a vehicle control system.

FIG. 32 is an explanatory diagram illustrating an example of installation positions of an outside-vehicle information detecting section and an imaging section.

### MODE FOR CARRYING OUT THE INVENTION

Hereinafter, embodiments of a photodetection element and an electronic device will be described with reference to the drawings. Although principal components of the photodetection element and the electronic device will be mainly described below, the photodetection element and the electronic device may include components and functions that are not illustrated or described. The following description is not intended to exclude components and functions that are not illustrated or described.

### First Embodiment

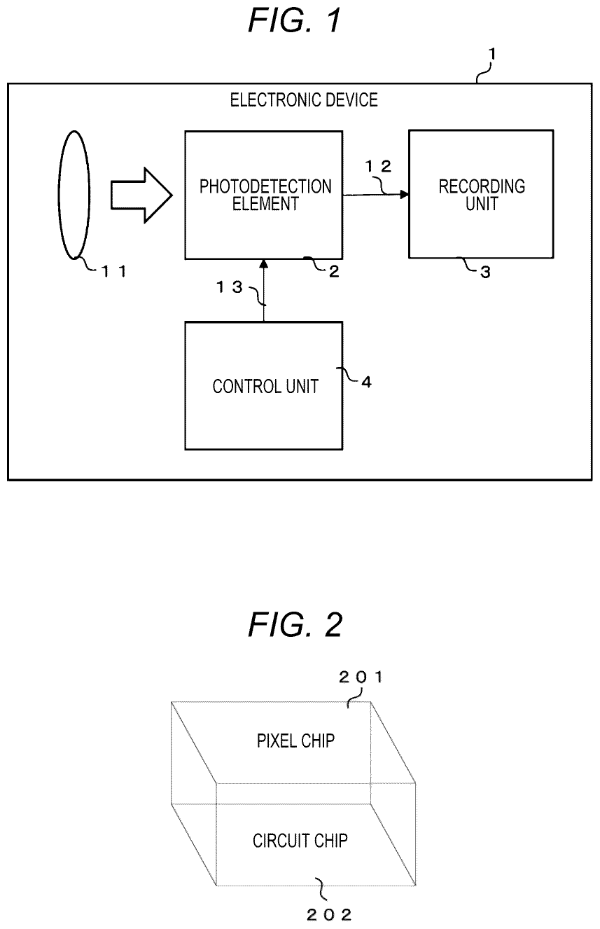

FIG. 1 is a block diagram of an electronic device 1 in a first embodiment of the present disclosure. The electronic device 1 captures image data, and includes an imaging lens 11, a photodetection element 2, a recording unit 3, and a control unit 4. As the electronic device 1, for example, a camera mounted on an industrial robot, a vehicle-mounted camera, or the like is assumed; however, the electronic device 1 has any specific application and configuration.

The imaging lens 11 condenses and guides incident light to the photodetection element 2. The photodetection element 2 photoelectrically converts the incident light to capture image data. The photodetection element 2 is, for example, an EVS, executes predetermined signal processing such as image recognition processing on the captured image data, and outputs the processed data to the recording unit 3 via a signal line 12. The image data output from the photodetection element 2 includes data based on an amount of change in an amount of incident light. More specifically, the image data includes event detection image data including information on an event detected in a case where an absolute value of the amount of change in the amount of incident light exceeds a threshold. Furthermore, the image data output from the photodetection element 2 may include gradation data including luminance corresponding to the amount of incident light and color information.

The recording unit 3 records the data from the photodetection element 2. The recording unit 3 may be disposed in a server or the like connected via a network. The control unit 4 controls the photodetection element 2 via a control line 13 to capture image data.

FIG. 2 is a diagram illustrating an example of a stacked structure of the photodetection element 2. The photodetection element 2 includes a light receiving chip 21 and a detection chip 22 stacked on the light receiving chip 21. These chips are bonded together by vias or the like. Note that they can also be bonded together by Cu-Cu bonding or bumps in addition to the vias.

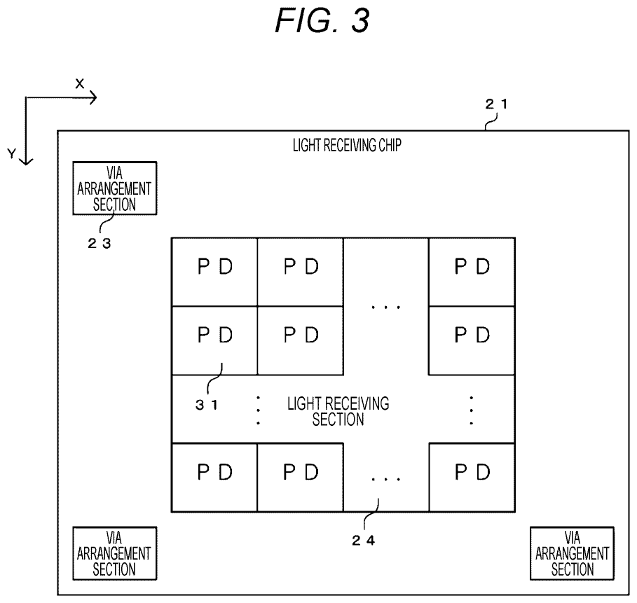

FIG. 3 is a plan view illustrating an example of the light receiving chip 21. The light receiving chip 21 is provided with a light receiving section 24 and a plurality of via arrangement sections 23.

In the via arrangement section 23, vias are disposed for transmitting and receiving various signals to and from the detection chip 22. Furthermore, in the light receiving section 24, a plurality of photoelectric conversion elements 31 is arranged in a first direction X and a second direction Y. In the present specification, the horizontal direction in FIG. 3 is referred to as the first direction X, and the vertical direction in FIG. 3 is referred to as the second direction Y. Each photoelectric conversion element 31 photoelectrically converts incident light and accumulates charges (hereinafter, photocharges) corresponding to the amount of incident light.

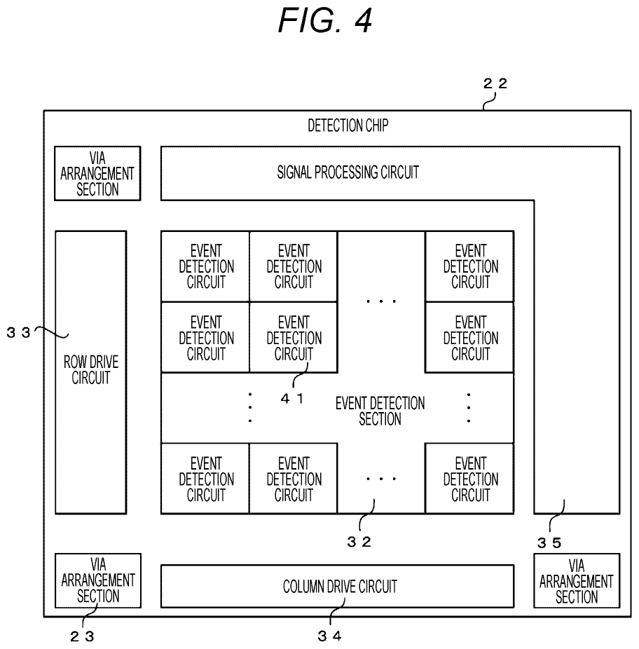

FIG. 4 is a plan view illustrating an example of the detection chip 22. The detection chip 22 is provided with the via arrangement section 23, an event detection section 32, a row drive circuit 33, a column drive circuit 34, and a signal processing circuit 35. In the via arrangement section 23, one or more vias are disposed for transmitting and receiving various signals to and from the light receiving chip 21.

The event detection section 32 generates a detection signal of an event based on the amount of change in the amount of incident light to the plurality of photoelectric conversion elements 31, and outputs the detection signal to the signal processing circuit 35.

In the event detection section 32, a plurality of event detection circuits (pixel circuits) 41 is arranged in a two-dimensional lattice pattern. A part of each event detection circuit 41 may be disposed on the light receiving chip 21 side.

The event detection circuit 41 quantizes a voltage signal corresponding to the photocharges from a corresponding one of the photoelectric conversion elements 31 and outputs the quantized voltage signal as a detection signal. Each of the event detection circuits 41 has a pixel address assigned, and is connected to the photoelectric conversion element 31 having the same address. The photoelectric conversion element 31 and the event detection circuit 41 constitute one pixel. A plurality of pixels is arranged in a two-dimensional lattice pattern similarly to the photoelectric conversion elements 31 and the event detection circuits 41, and constitutes a pixel array unit described later. As will be described later, some pixels of the pixel array unit may have the photoelectric conversion element 31 and the pixel circuit without having the event detection circuit. Such some pixels are referred to as gradation pixels, in the present specification.

The row drive circuit 33 selects a row address and causes the event detection section 32 to output a detection signal corresponding to the row address.

The column drive circuit 34 selects a column address and causes the event detection section 32 to output a detection signal corresponding to the column address.

The signal processing circuit 35 executes predetermined signal processing on the detection signal from the event detection section 32 to generate image data. The signal processing circuit 35 may execute any signal processing such as image recognition processing or inference processing on the generated image data.

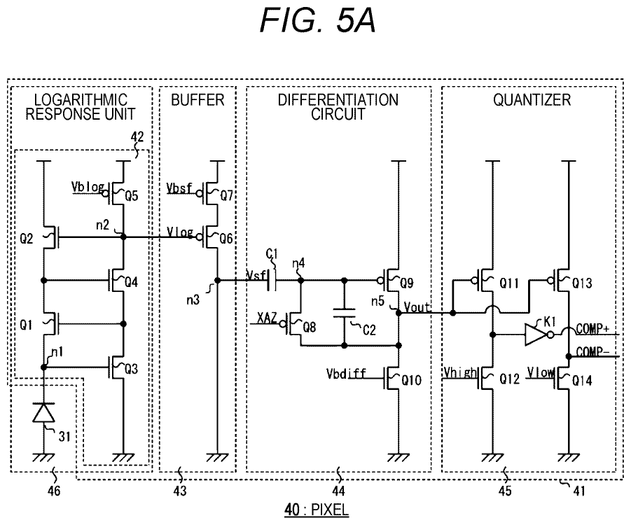

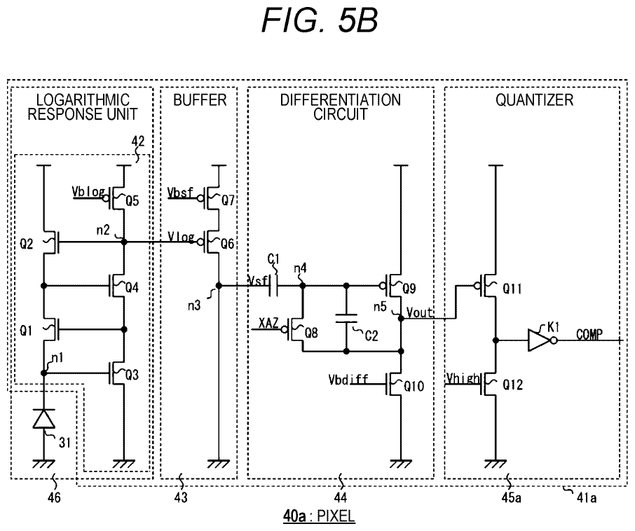

FIG. 5A is a circuit diagram illustrating a first example of a pixel 40. The pixel 40 includes the photoelectric conversion element 31 and the event detection circuit 41. The event detection circuit 41 includes a current-voltage conversion circuit (charge-voltage conversion circuit) 42, a buffer 43, a differentiation circuit 44, and a quantizer 45. The current-voltage conversion circuit 42 and the photoelectric conversion element 31 constitute a logarithmic response unit 46.

The logarithmic response unit 46 performs logarithmic conversion on the charges photoelectrically converted by the photoelectric conversion element 31 to generate a voltage signal Vlog. A reason for the logarithmic conversion is to widen a dynamic range of the pixel 40 for acquiring luminance information.

The photoelectric conversion element 31 accumulates charges (photocharges) based on incident light incident on the pixel 40 corresponding thereto. As the photoelectric conversion element 31, for example, a photodiode is used. The photoelectric conversion element 31 includes an anode and a cathode. One of the anode or the cathode (for example, the cathode) is connected to an input node n1 of the current-voltage conversion circuit 42, and the other (for example, the anode) is connected to a predetermined reference voltage node such as a ground voltage.

The current-voltage conversion circuit 42 converts the charges accumulated in the photoelectric conversion element 31 into a voltage. The current-voltage conversion circuit 42 includes a transistor Q1, a transistor Q2, a transistor Q3, a transistor Q4, and a transistor Q5. As the transistors Q1 to Q4, for example, NMOS transistors are used. For the transistor Q5, for example, a PMOS transistor is used.

The transistors Q1 and Q2 are cascode-connected between a power supply voltage node and a predetermined photoelectric conversion element 31. The source of the transistor Q1 is connected to the cathode of the photoelectric conversion element 31 and the gate of the transistor Q3, and the gate of the transistor Q1 is connected to the drain of the transistor Q3 and the source of the transistor Q4. The drain of the transistor Q2 is connected to the power supply voltage node, and the gate is connected to an output node n2 of the current-voltage conversion circuit 42, the drain of the transistor Q4, the drain of the transistor Q5, and an input node of the buffer 43.

The transistor Q3 and the transistor Q4 are cascode-connected between the node n2 and a reference voltage (ground) node. The source of the transistor Q3 is connected to the reference voltage (ground) node, and the gate is connected to the source of the transistor Q1 and the cathode of the photoelectric conversion element 31. The transistor Q4 is disposed between the transistor Q3 and the transistor Q5, the gate of the transistor Q4 is connected to the drain of the transistor Q1 and the source of the transistor Q2, and the drain of the transistor Q4 is connected to the output node n2.

The source of the transistor Q5 is connected to the power supply voltage node, and a bias voltage Vblog is applied to the gate. The transistor Q5 adjusts a voltage level at the output node n2 by a voltage level of the bias voltage Vblog.

The voltage signal Vlog obtained by the logarithmic conversion by the current-voltage conversion circuit 42 is input to the buffer 43. The buffer 43 includes a transistor Q7 and a transistor Q6 cascode-connected between the power supply voltage node and the reference voltage (for example, ground) node. For the transistors Q6 and Q7, for example, PMOS transistors are used.

The transistor Q6 in the buffer 43 constitutes a source follower circuit. A pixel voltage Vsf corresponding to the voltage signal Vlog output from the current-voltage conversion circuit 42 is output from the buffer 43. The voltage signal Vlog is input to the gate of the transistor Q6 from the output node n2 of the current-voltage conversion circuit 42. The source of the transistor Q6 is connected to the power supply voltage node, and the drain is connected to the differentiation circuit 44 via an output node n3 of the buffer 43.

The source of the transistor Q7 is connected to the power supply voltage node, and the drain is connected to the source of the transistor Q6. A bias voltage Vbsf is applied to the gate of the transistor Q7. The transistor Q7 adjusts a voltage level of the source of the transistor Q6 in accordance with a voltage level of the bias voltage Vbsf.

The pixel voltage Vsf output from the buffer 43 is input to the differentiation circuit 44. The buffer 43 can improve the driving force of the pixel voltage Vsf. Furthermore, by providing the buffer 43, it is possible to secure isolation that prevents noise generated when the differentiation circuit 44 at the subsequent stage performs the switching operation from being transmitted to the current-voltage conversion circuit 42.

The differentiation circuit 44 generates a differential signal Vout according to a change in the voltage signal Vlog converted by the current-voltage conversion circuit 42. The differentiation circuit 44 includes a capacitor C1 and transistors Q8 to Q10. For the transistor Q10, an NMOS transistor is used, for example, and for the transistors Q8 and Q9, PMOS transistors are used, for example.

The capacitor C1 is disposed between a connection node n4 of the source of the transistor Q8 and the gate of the transistor Q9 and the output node n3 of the buffer 43. The capacitor Cl supplies a current corresponding to an amount of change in the pixel voltage Vsf obtained by time-differentiation of the pixel voltage Vsf output from the buffer 43 to the source of the transistor Q8 and the gate of the transistor Q9.

The transistor Q8 switches whether or not to short-circuit the gate and the drain of the transistor Q9 in accordance with an auto-zero signal XAZ. The auto-zero signal XAZ is a signal to give an instruction for initialization, and for example, changes from a high level to a low level every time an event detection signal to be described later is output from the pixel 40. When the auto-zero signal XAZ is at the low level, the transistor Q8 is turned on, the differential signal Vout is set to an initial value, and charges of the capacitor Cl are initialized.

The source of the transistor Q10 is connected to the reference voltage (for example, ground) node, and a bias voltage Vbdiff is applied to the gate. The transistor Q10 adjusts a voltage level at an output node n5 of the differentiation circuit 44 in accordance with a voltage level of the bias voltage Vbdiff.

The transistor Q9 and the transistor Q10 function as an inversion circuit having the connection node n4 on the gate side of the transistor Q9 as an input node and the connection node n5 of the transistor Q9 and the transistor Q10 as an output node.

As described above, the differentiation circuit 44 detects the amount of change in the pixel voltage Vsf by a differential operation. The amount of change in the pixel voltage Vsf indicates the amount of change in the amount of incident light in the pixel 40. The differentiation circuit 44 supplies the differential signal Vout to the quantizer 45 via the output node n5.

The quantizer 45 performs a comparison operation of comparing the differential signal Vout with a threshold voltage. The quantizer 45 detects an event indicating that an absolute value of the amount of change in the amount of incident light exceeds the threshold voltage on the basis of a result of the comparison operation, and outputs an event detection signal COMP+ and an event detection signal COMP−. The quantizer 45 includes transistors Q11 to Q14 and an inverter K1. As the transistors Q11 and Q13, for example, PMOS transistors are used. Furthermore, as the transistors Q12 and Q14, for example, NMOS transistors are used.

The transistors Q11 and Q12 are cascode-connected between the power supply voltage node and the reference voltage (for example, ground) node. The output signal Vout of the differentiation circuit 44 is applied to the gate of the transistor Q11. A threshold voltage Vhigh is applied to the gate of the transistor Q12. The transistors Q11 and Q12 compare the output signal Vout with the threshold voltage Vhigh. Specifically, when the output signal Vout of the differentiation circuit 44 is lower than the threshold voltage Vhigh, the transistor Q11 is turned on and the event detection signal COMP+ output from the drain of the transistor Q11 via the inverter K1 is at the low level.

The transistors Q13 and Q14 are cascode-connected between the power supply voltage node and the reference voltage (for example, ground) node. The output signal Vout of the differentiation circuit 44 is applied to the gate of the transistor Q13. A threshold voltage Vlow is applied to the gate of the transistor Q14. The transistors Q13 and Q14 compare the output signal Vout with the threshold voltage Vlow. Specifically, when the output signal Vout of the differentiation circuit 44 is higher than the threshold voltage Vlow, the transistor Q13 is turned off and the event detection signal COMP− output from the drain of the transistor Q13 is at the low level.

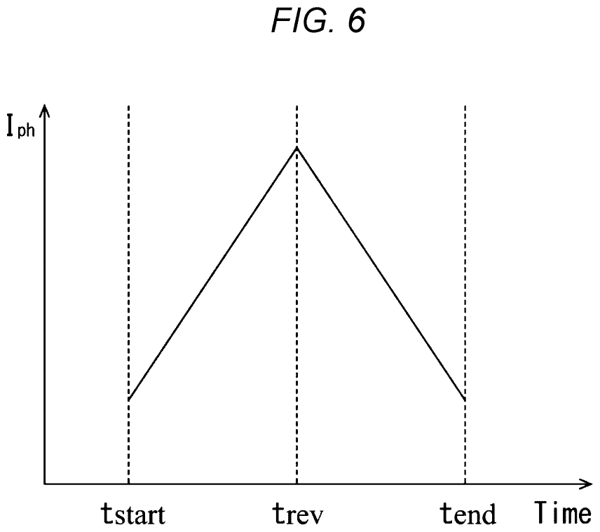

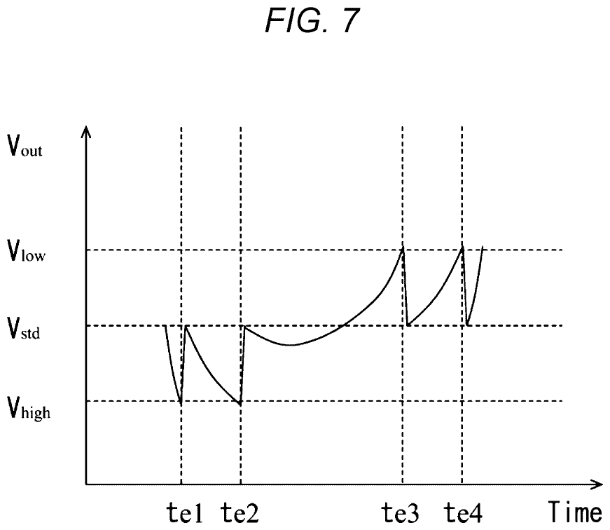

Hereinafter, the output of the event detection signals COMP+ and COMP− in the pixel 40 illustrated in FIG. 5A will be described with reference to FIGS. 6 and 7. FIG. 6 is a graph illustrating a change in a current Iph flowing through an input node of the differentiation circuit 44. In the graph of FIG. 6, the vertical axis represents the current Iph, and the horizontal axis represents time. In FIG. 6, an amount of light incident on the pixel 40 increases from a time tstart to a time trev. In this case, photocharges are generated by the photoelectric conversion element 31, and a voltage at the input node n1 connected to the cathode of the photoelectric conversion element 31 decreases. As the voltage at the input node n1 decreases, a voltage level of the output voltage Vlog of the current-voltage conversion circuit 42 decreases, the output voltage Vsf of the buffer 43 also decreases, and the current Iph flowing through the input node of the differentiation circuit 44 increases.

FIG. 7 is a graph illustrating a change in the output voltage Vout of the differentiation circuit 44. In the graph of FIG. 7, the vertical axis represents the output voltage Vout, and the horizontal axis represents time. The differentiation circuit 44 decreases the output voltage Vout as an amount of increase per unit time in the current Iph is larger. When the output voltage Vout falls below the threshold voltage Vhigh, for example, at a time te1, the quantizer 45 outputs the event detection signal COMP+ at the low level. The event detection signal COMP+ is at the low level, whereby a first event is detected.

When the event detection signal COMP+ is at the low level, the auto-zero signal XAZ is at the low level, and the output voltage Vout of the differentiation circuit 44 is reset to a reference voltage Vstd. In a case where the increase in the current Iph continues after the time te1, the output voltage Vout falls below the threshold voltage Vhigh again at a time te2, for example. Similarly, at the time te2, the quantizer 45 outputs the event detection signal COMP+ at the low level.

In FIG. 6, the amount of light incident on the pixel 40 decreases from the time trev to a time tend. In this case, generation of photocharges by the photoelectric conversion element 31 is reduced, and the voltage at the input node n1 increases. As the voltage at the input node n1 increases, the voltage level of the output voltage Vlog of the current-voltage conversion circuit 42 increases, the output voltage Vsf of the buffer 43 also increases, and the current Iph flowing through the input node of the differentiation circuit 44 decreases.

The differentiation circuit 44 increases the output voltage Vout as an amount of decrease per unit time in the current Iph is larger. When the output voltage Vout exceeds the threshold voltage Vlow at times te3 and te4 in FIG. 7, for example, the quantizer 45 outputs the event detection signal COMP− at the low level. The event detection signal COMP− is at the low level, whereby a second event is detected. As described above, the pixel 40 detects an increase or decrease in the amount of light incident on the photoelectric conversion element 31, and outputs the event detection signal COMP+ or COMP−.

In the present specification, the event detection signals COMP+ and COMP− are also collectively referred to as event detection signals COMP. The event detection signal COMP+ is at the low level in a case where the amount of change in the amount of incident light rapidly increases, and the event detection signal COMP− is at the low level in a case where the amount of change in the amount of incident light rapidly decreases. Furthermore, in the present specification, a case where the event detection signal COMP+ transitions to the low level is also referred to as the first event, and a case where the event detection signal COMP− transitions to the low level is also referred to as the second event.

The pixel 40 does not need to detect both the event detection signal COMP+ and the event detection signal COMP−, and may detect either one. FIG. 5B is a circuit diagram illustrating a second example of the pixel 40. A quantizer 45a illustrated in FIG. 5B is different from the quantizer 45 in FIG. 5A in that the quantizer 45a does not include the transistors Q13 and Q14.

For this reason, a pixel 40a (and an event detection circuit 41a) in FIG. 5B detects only the increase in the increase or decrease of the amount of incident light in the photoelectric conversion element 31, and outputs the event detection signal COMP.

Similarly, the pixel 40 may have a configuration in which the transistors Q11 and Q12 and the inverter Kl are removed from the quantizer 45 in FIG. 5A. In that case, the pixel 40 detects only the decrease in the increase or decrease in the amount of received light in the photoelectric conversion element 31. Alternatively, the pixel 40 may detect the event in a case where the amount of incident light rapidly changes without distinguishing a case where the amount of incident light rapidly increases and a case where the amount of incident light rapidly decreases from each other. In this case, the circuit configuration of the differentiation circuit 44 needs to be different from those in FIGS. 5A and 5B.

The output signal Vout of the differentiation circuit 44 may decrease or increase due to influence of noise due to heat or the like of the transistor in the current-voltage conversion circuit 42. As a result, in the quantizer 45. The event detection signal COMP+ or COMP− may unexpectedly transition to the low level. An event due to an unexpected factor is referred to as a noise event, in the present specification. In particular, in a case where sensitivity of the pixel 40 to incident light is high, a large number of noise events may be detected.

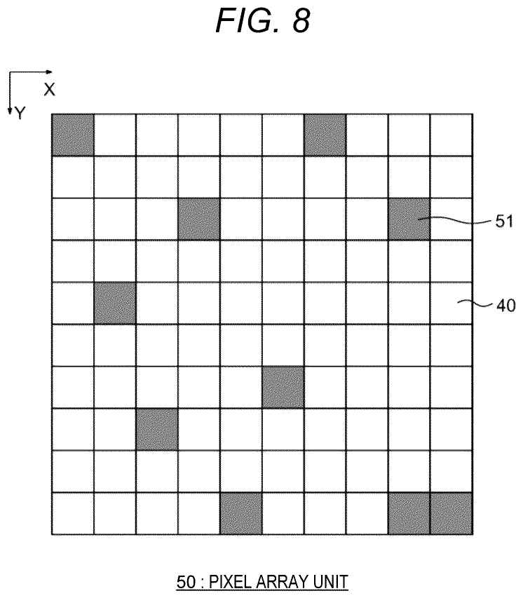

FIG. 8 is a diagram illustrating an example of occurrence of a noise event in a pixel array unit 50. A noise event 51 may occur randomly at each pixel 40, regardless of a change in the amount of incident light. In a case where all the pixels 40 in the pixel array unit 50 can detect an event, a large number of the noise events 51 may be detected. The photodetection element according to each embodiment described below is characterized by being able to solve this problem.

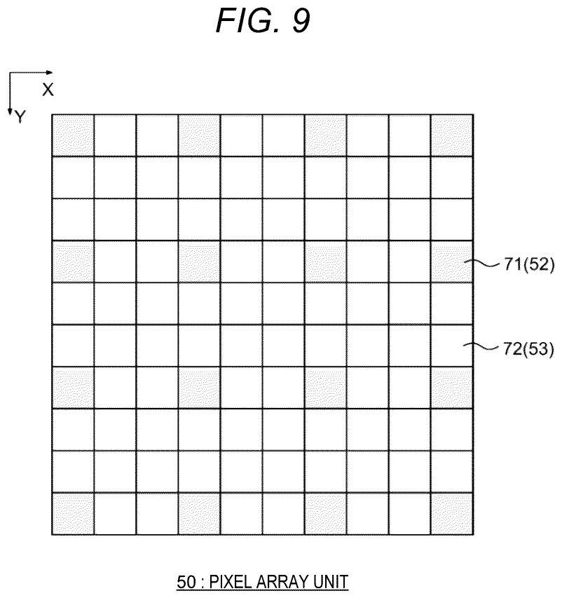

FIG. 9 is a plan view of the pixel array unit 50 in the first embodiment of the present disclosure. The pixel array unit 50 in FIG. 9 includes a first pixel region 71 and a second pixel region 72. The first pixel region 71 includes a plurality of first pixels 52 each performing detection of an event based on the amount of change in the amount of incident light. The second pixel region 72 is disposed in the vicinity of the first pixel region 71 and includes a second pixel 53 that performs detection of an event around a first pixel 52 in which the event is detected among the plurality of first pixels 52.

The plurality of first pixels 52 in the first pixel region 71 is disposed apart from each other with a pixel (in the example of FIG. 9, the second pixel 53) other than the first pixel 52 interposed therebetween in the first direction X and the second direction Y intersecting each other.

The first pixels 52 are intermittently disposed in the pixel array unit 50. The second pixel 53 is a pixel other than the first pixels 52 in the pixel array unit 50. Each of a plurality of the first pixels 52 can always detect an event, whereas each of a plurality of the second pixels 53 is associated with a specific first pixel 52, and enabled to detect an event only in a case where the first pixel 52 corresponding thereto has detected the event.

Arrangement locations and number of the plurality of first pixels 52 in the first pixel region 71 are any locations and number, and are not limited to those illustrated in FIG. 9.

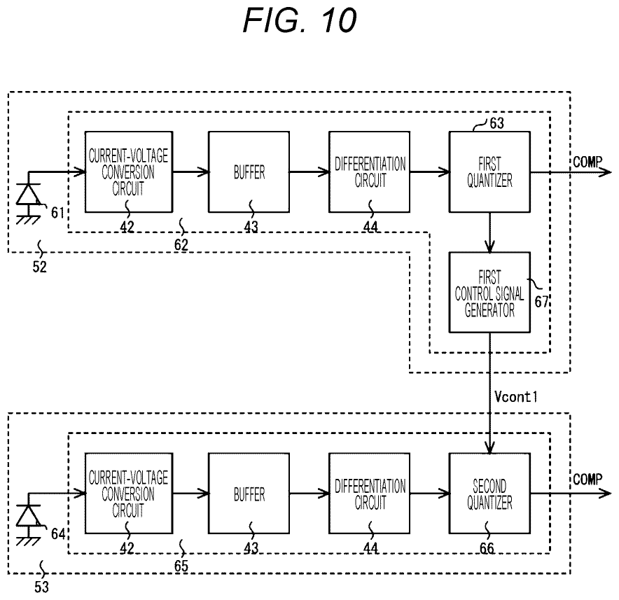

FIG. 10 is a block diagram of the first pixel 52 and the second pixel 53 in the first embodiment of the present disclosure. The photodetection element 2 in the first embodiment of the present disclosure includes one or more each of the first pixels 52 and the second pixels 53 in the pixel array unit 50.

The first pixel 52 includes a first photoelectric conversion element 61 and a first pixel circuit 62. Similarly to the photoelectric conversion element 31 in FIG. 5A, the first photoelectric conversion element 61 accumulates photocharges corresponding to an amount of incident light incident on the first pixel 52.

The first pixel circuit 62 includes an event detection circuit having a configuration similar to that of the event detection circuit 41 in FIG. 5A (or the event detection circuit 41a in FIG. 5B). The first pixel circuit 62 detects an event on the basis of the photocharges accumulated by the first photoelectric conversion element 61. The event detection circuit in the first pixel circuit 62 includes the current-voltage conversion circuit 42, the buffer 43, the differentiation circuit 44, and a first quantizer 63.

Furthermore, the first pixel circuit 62 includes a first control signal generator 67. The first pixel circuit 62 outputs the event detection signal COMP indicating a result of detection of the first event or the second event. When the first event or the second event is detected, the first control signal generator 67 outputs a first control signal Vcont1 of predetermined logic (for example, high level) separately from the event detection signal COMP.

Similarly to the first pixel 52, the second pixel 53 includes a second photoelectric conversion element 64 and a second pixel circuit 65. The second photoelectric conversion element 64 accumulates photocharges corresponding to an amount of incident light incident on the second pixel 53. The second pixel circuit 65 detects an event on the basis of the photocharges accumulated in the second photoelectric conversion element 64 only when the first control signal Vcont1 in the first pixel 52 corresponding thereto has the predetermined logic. The second pixel circuit 65 includes the current-voltage conversion circuit 42, the buffer 43, the differentiation circuit 44, and a second quantizer 66. As described above, the second pixel 53 is different from the first pixel 52 in that the first control signal generator 67 in the first pixel 52 is not included.

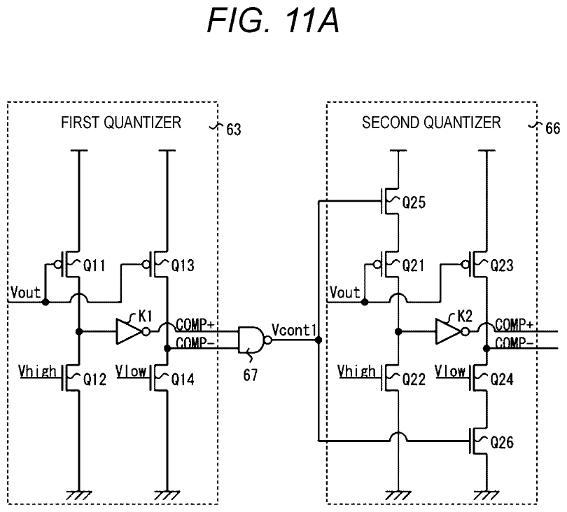

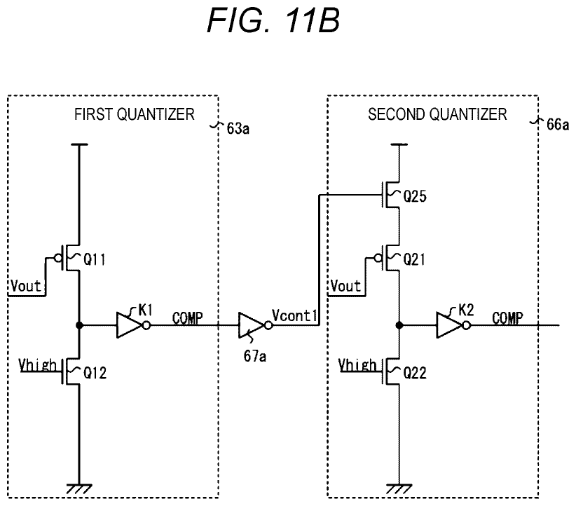

The first control signal generator 67 generates the first control signal Vcont1 on the basis of the event detection signals COMP+ and COMP− output from the first quantizer 63, and inputs the first control signal Vcont1 to the second quantizer 66. Details of the first control signal generator 67, the first quantizer 63, and the second quantizer 66 will be described with reference to FIGS. 11A and 11B.

FIG. 11A is a circuit diagram illustrating a first example of the first control signal generator 67, the first quantizer 63, and the second quantizer 66 in the first embodiment of the present disclosure. The first quantizer 63 and the first control signal generator 67 are a part of the first pixel 52, and the second quantizer 66 is a part of the second pixel 53.

The first quantizer 63 includes the transistors Q11 to Q14 and the inverter K1, similarly to the quantizer 45 in FIG. 5A. Similarly to the first quantizer 63, the second quantizer 66 includes an inverter K2 and transistors Q21 to Q24 respectively corresponding to the transistors Q11 to Q14. The second quantizer 66 further includes a transistor Q25 and a transistor Q26.

For the transistors Q25 and Q26, for example, NMOS transistors are used. The transistor Q25 switches whether or not to connect the drain of the transistor Q21 and the power supply voltage node to each other. The transistor Q26 switches whether or not to connect the source of the transistor Q24 and the reference voltage (for example, ground) node to each other. The first control signal Vcont1 is input from the first control signal generator 67 to the transistors Q25 and Q26.

When the first control signal Vcont1 at the low level is input to the transistors Q25 and Q26, the transistors Q25 and Q26 are in an off state. When the transistor Q25 is in the off state, the transistors Q21 and Q22 are disconnected from the power supply voltage node, and the second quantizer 66 does not compare the output signal Vout with the threshold voltage Vhigh. When the transistor Q26 is in the off state, the transistors Q23 and Q24 are disconnected from the reference voltage (ground) node, and the second quantizer 66 does not compare the output signal Vout with the threshold voltage Vlow.

The first control signal generator 67 includes, for example, a NAND circuit. The event detection signals COMP+ and COMP− output from the first quantizer 63 are input to the first control signal generator 67. Note that the event detection signals COMP+ and COMP− are input to the first control signal generator 67 and input to, for example, an output circuit at the subsequent stage.

When one of the event detection signals COMP+ and COMP− is at the low level, the first control signal generator 67 outputs the first control signal Vcont1 at the high level. Both the transistors Q25 and Q26 of the second quantizer 66 are in on states when the first control signal Vcont1 at the high level is input.

When the transistor Q25 is in the on state, the transistors Q21 and Q22 compare the output signal Vout with the threshold voltage Vhigh, and the second quantizer 66 can output the event detection signal COMP+ at the low level.

When the transistor Q26 is in the on state, the transistors Q23 and Q24 compare the output signal Vout with the threshold voltage Vlow, and the second quantizer 66 can output the event detection signal COMP− at the low level.

That is, when the first control signal Vcont1 is at the high level, the second quantizer 66 performs a comparison operation between the output signal Vout and the threshold voltage Vhigh or between the output signal Vout and the threshold voltage Vlow. As a result, the second quantizer 66 can detect an event. As described above, the first control signal Vcont1 indicating an event detection result in the first pixel 52 is input to the second pixel 53, whereby the second pixel 53 associated with the first pixel 52 performs event detection only when the first pixel 52 has detected an event.

FIG. 11B is a diagram illustrating a second example of a first control signal generator 67a, a first quantizer 63a, and a second quantizer 66a in the first embodiment of the present disclosure. The first quantizer 63a and the first control signal generator 67 are a part of the first pixel 52, and the second quantizer 66a is a part of the second pixel 53. The first quantizer 63a and the second quantizer 66a detect an event in a case where the amount of incident light rapidly increases, and do not detect an event in a case where the amount of incident light rapidly decreases.

The first control signal generator 67a includes, for example, an inverter. Similarly to the example of FIG. 11A, when a COMP signal is input from the first quantizer 63a to the first control signal generator 67a and the COMP signal is at the low level, the first control signal Vcont1 at the high level is output. The second quantizer 66a includes the transistor Q25 to which the first control signal Vcont1 is input. When the first control signal Vcont1 at the high level is input, the transistor Q25 is in the on state, and the second quantizer 66a performs a comparison operation between the output signal Vout and the threshold voltage Vhigh and detection of an event.

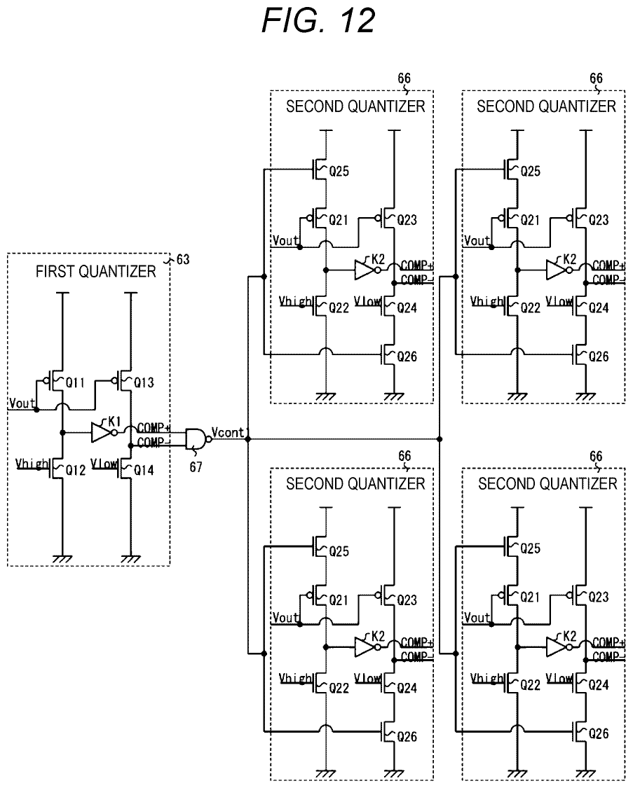

The first control signal generator 67 illustrated in FIG. 11A may be connected to a plurality of the second quantizers 66 in a plurality of the second pixels 53. FIG. 12 is a circuit diagram illustrating an example in which the first quantizer 63 in one first pixel 52 is connected to the plurality of second quantizers 66 in the plurality of second pixels 53 via the first control signal generator 67. The first control signal Vcont1 of the first control signal generator 67 is input to the gates of a plurality of the transistors Q25 and the gates of a plurality of the transistors Q26 in the plurality of second quantizers 66. As a result, one first pixel 52 is associated with the plurality of second pixels 53. Note that also the first control signal generator 67a illustrated in FIG. 11B can be similarly connected to a plurality of the second quantizers 66a in the plurality of second pixels 53. In the case of FIG. 12, when any of the first pixels 52 in the first pixel region 71 detects an event, the plurality of second pixels 53 associated with the any of the first pixels 52 is enabled to detect the event. As a result, the event can be detected by the plurality of second pixels 53 around the first pixel 52 that has detected the event.

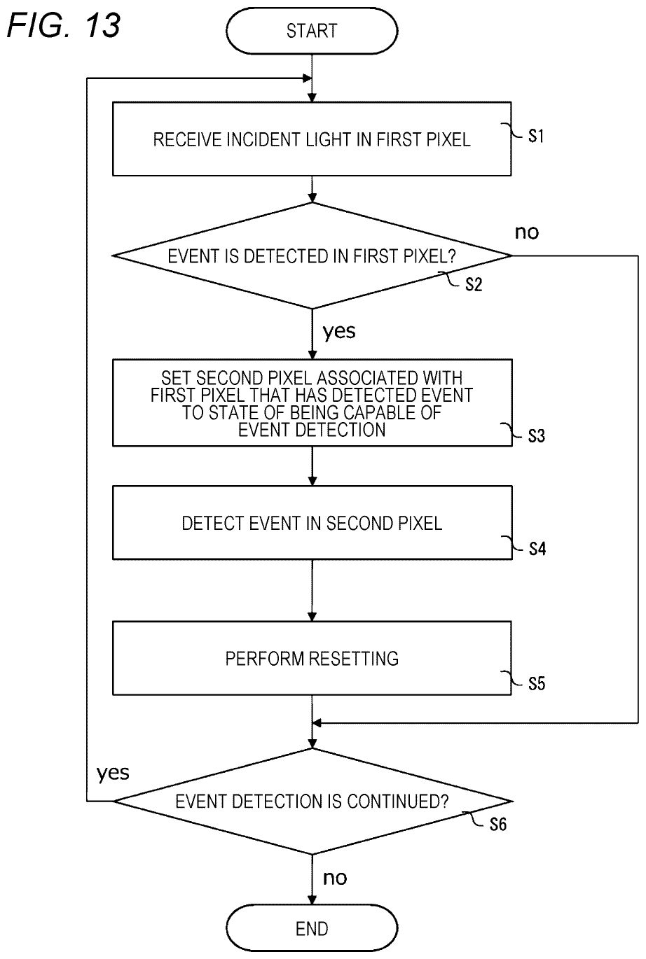

FIG. 13 is a flowchart illustrating an event detection operation of the photodetection element 2 in the first embodiment of the present disclosure. The plurality of first pixels 52 included in the first pixel region 71 in the pixel array unit 50 receives incident light (step S1). When luminance of an object changes, an amount of incident light received by the pixel array unit 50 in the photodetection element 2 changes.

In each of the plurality of first pixels 52 in the pixel array unit 50, the first quantizer 63 compares the output signal Vout of the differentiation circuit 44 with the threshold voltage Vhigh or Vlow, and performs an operation of determining whether or not an event is detected (step S2).

When no event is detected in the first pixel 52, the transistors Q25 and Q26 in the second pixel 53 associated with the first pixel 52 are in the off states, and the second pixel 53 does not perform the event detection operation.

In a case where an event is detected in the first pixel 52, the transistors Q25 and Q26 in the second pixel 53 are in the on states (step S3). As a result, the second pixel 53 associated with the first pixel 52 performs event detection (step S4).

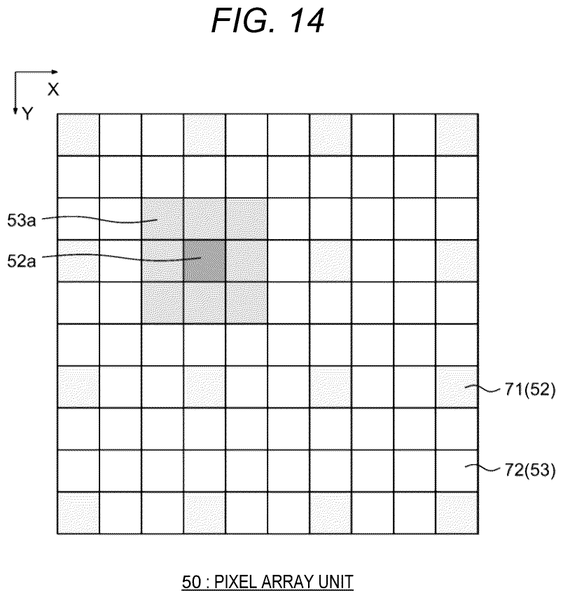

FIG. 14 is a plan view illustrating an example of event detection in the pixel array unit 50. FIG. 14 illustrates an example in which event detection is performed in the first pixel 52 and the second pixel 53 associated with the first pixel 52. A first pixel 52a in FIG. 14 indicates the first pixel 52 that has detected the event is detected in step S3.

One or more second pixels 53a associated with the first pixel 52a are disposed around the first pixel 52a. In the example in FIG. 14, eight second pixels 53a are disposed so as to surround the first pixel 52a. In step S4, detection of an event is performed in all (in FIG. 14, eight) second pixels 53a associated with the first pixel 52a.

There is a high possibility that a true event detected in a case where the amount of incident light rapidly changes is detected not only in one pixel but also detected substantially simultaneously in a plurality of pixels 40 within a predetermined pixel range. Thus, as illustrated in FIG. 14, by detecting the event by the second pixels 53a around the first pixel 52a that has detected the event, it is possible to accurately detect the true event based on the change in the amount of incident light.

In a case where the second pixel 53a has detected an event, each pixel 40 (or pixel 40a) in the pixel array unit 50 is reset (step S5). Specifically, the auto-zero signal XAZ at the low level is input to each pixel 40. Note that the first pixel 52 may be reset when YES is obtained in step S2.

In a case where determination is performed as NO in step S2, or after the processing in step S5 ends, it is determined whether or not to continue detection of an event (step S6). In a case where the event detection is continued, the event detection operation is repeated from step S1. In a case where the event detection is not continued, the processing in FIG. 13 ends.

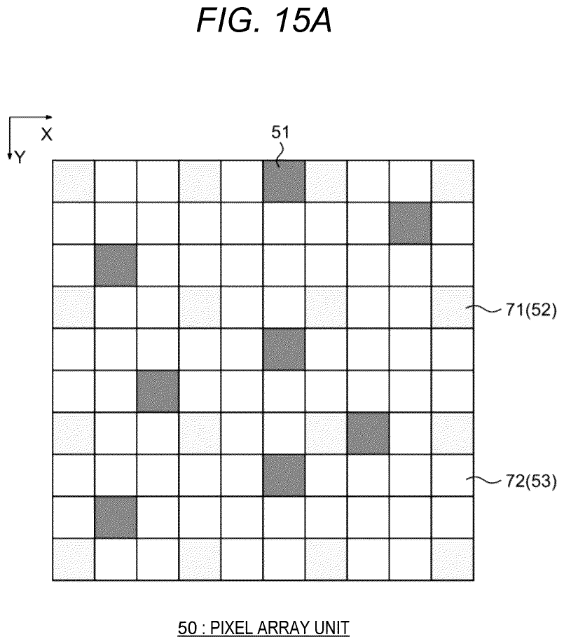

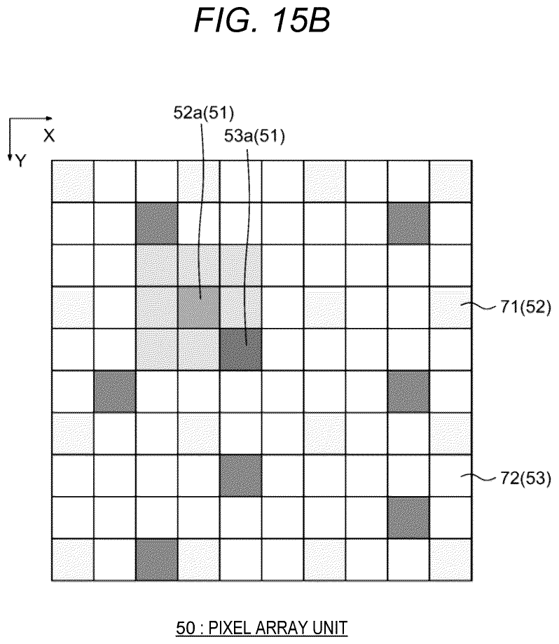

FIG. 15A is a plan view illustrating an example in which the noise event 51 occurs in some pixels in the pixel array unit 50 in the first embodiment of the present disclosure. The example of FIG. 15A illustrates an example in which a pixel position where the noise event 51 has occurred is in the second pixel region 72. In this case, since no event is detected in the first pixel 52, the event detection signal COMP based on the noise event 51 is not output from the second pixel 53. Thus, in the example of FIG. 15A, no noise event 51 is detected. Furthermore, by disposing the plurality of first pixels 52 in the pixel array unit 50 in a distributed manner, it is possible to reduce a probability that the plurality of first pixels 52 detects the noise event 51.

FIG. 15B is a plan view illustrating an example in which some of the first pixels 52 detect the noise event 51 in the pixel array unit 50 in the first embodiment of the present disclosure. FIG. 15B illustrates an example in which one first pixel 52a of the plurality of first pixels 52 in the pixel array unit 50 detects the noise event 51. In this case, an example is illustrated in which the event detection operation is performed in a plurality of the second pixels 53 located around the first pixel 52a, and one second pixel 53a among them detects the noise event 51. For a true event based on the change in the amount of incident light, the event is often detected by the plurality of second pixels 53 located around the first pixel 52a that has detected the event. As illustrated in FIG. 15B, in a case where only one second pixel 53a of the plurality of second pixels 53 detects an event, it can be determined that a noise event has been detected.

As described above, in the first embodiment, the pixel array unit 50 is divided into the first pixel region 71 and the second pixel region 72, and each first pixel 52 in the first pixel region 71 is enabled to always detect an event, and each second pixel 53 in the second pixel region 72 is enabled to detect the event only when the first pixel 52 associated detects the event. As a result, the number of pixels capable of detecting an event can be reduced, and a possibility of erroneously detecting the noise event is reduced. Furthermore, since an event based on the change in the amount of incident light is often detected in a plurality of pixels within a predetermined pixel range, by setting the second pixel 53 located around the first pixel 52 that has detected the event to a state of being capable of event detection, it is possible to detect a true event in detail while minimizing influence of the noise event.

Since the photodetection element 2 according to the present embodiment enables only some of the first pixels 52 in the pixel array unit 50 to detect an event, it is possible to reduce power consumption as compared with a case where all the pixels in the pixel array unit 50 are enabled to detect an event at all times. Furthermore, since the second pixel 53 located around the first pixel 52 that has detected an event is enabled to detect the event, it is possible to detect in detail whether or not the event is detected around the first pixel 52 that has detected the event, and generate a high-resolution event detection image. Moreover, when an event is detected in the first pixel 52, the second pixel 53 associated is immediately enabled to detect the event, and thus, the event can be detected in the second pixel 53 without a time delay, and a final event detection result can be quickly output.

Furthermore, the photodetection element 2 of the present disclosure does not require subsequent-stage processing of thinning out event detection results after detecting an event in each pixel 40. As a result, the final event detection result can be quickly output. Furthermore, since the subsequent-stage processing is not required, manufacturing cost of the photodetection element 2 can be reduced.

### Second Embodiment

Various modifications are conceivable for sizes and shapes of the first pixel region 71 and the second pixel region 72 in the pixel array unit 50. The configuration of the pixel array unit 50 illustrated in FIG. 9 is effective for a flicker measure since the number of pixels capable of detecting an event is limited. However, in the case of receiving incident light from an object that constantly travels in a certain direction such as a droplet, it is desirable to determine the sizes and shapes of the first pixel region 71 and the second pixel region 72 in the pixel array unit 50 in accordance with characteristics of the object.

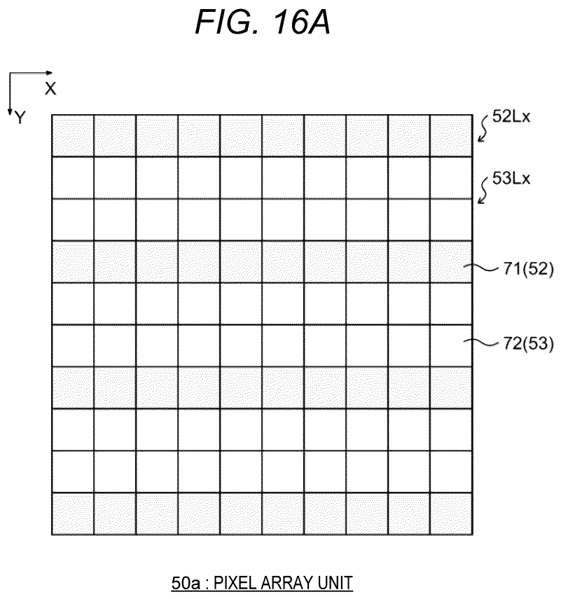

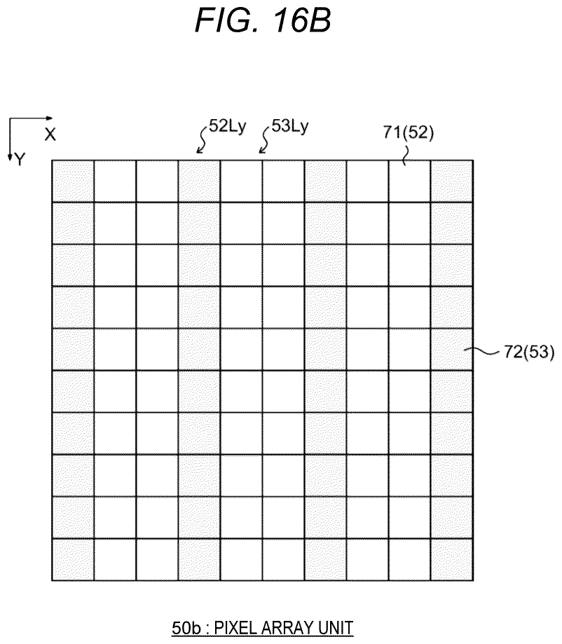

FIG. 16A is a plan view of a pixel array unit 50a according to a first example of a second embodiment of the present disclosure. The first pixel region 71 in the pixel array unit 50a illustrated in FIG. 16A includes a plurality of pixel rows 52Lx each extending in the first direction X. A plurality of the first pixels 52 in each pixel row 52Lx is disposed along the first direction X. The second pixel region 72 includes a plurality of pixel rows 53Lx disposed between the plurality of pixel rows 52Lx in the first pixel region 71. A plurality of the second pixels 53 in each pixel row 53Lx is disposed along the first direction X.

In the pixel array unit 50a, for example, the first pixel 52 and a plurality of the second pixels 53 disposed immediately below the first pixel 52 are associated with each other. For example, in a case where light reflected by a droplet falling downward from the top in FIG. 16A along the second direction Y is incident on the pixel array unit 50a, when an event is detected in the first pixel 52, there is a high possibility that the event is detected also in the second pixel 53 disposed immediately below the first pixel 52. Thus, the pixel array unit 50a illustrated in FIG. 16A can detect the event more reliably in a case where the incident light travels in the vertical phrase.

FIG. 16B is a plan view of a pixel array unit 50b according to a second example of the second embodiment of the present disclosure. The first pixel region 71 in the pixel array unit 50b illustrated in FIG. 16B includes a plurality of pixel columns 52Ly each extending in the second direction Y. A plurality of the first pixels 52 in each pixel column 52Ly is disposed along the second direction Y. The second pixel region 72 includes a plurality of pixel columns 53Ly disposed between the plurality of pixel columns 52Ly.

The pixel array unit 50b can accurately detect an event based on a change in an amount of incident light from an object moving in the first direction X.

As described above, the pixel array units 50a and 50b described in the second embodiment can accurately detect an event in a case where the amount of incident light changes along the second direction Y or the first direction X.

### Third Embodiment

A third embodiment is characterized by performing event detection suitable in the case of detecting a motion or the like in which an object moves from the outside to the inside.

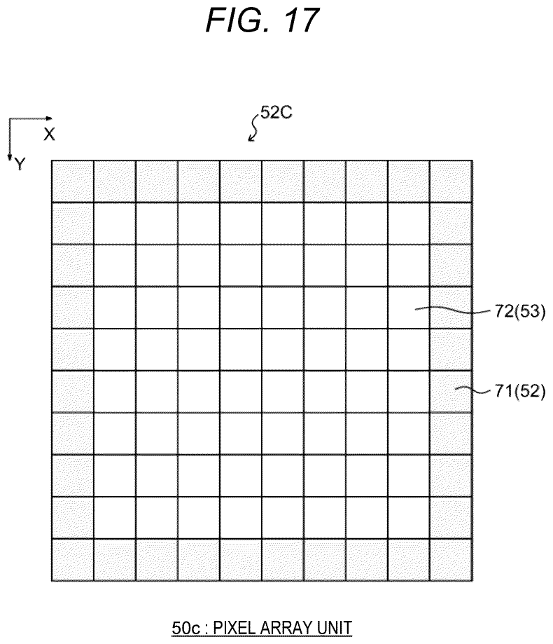

FIG. 17 is a plan view of the pixel array unit 50 in the third embodiment of the present disclosure. A pixel array unit 50c illustrated in FIG. 17 includes a plurality of the first pixels 52 and the second pixels 53 arranged in the first direction X and the second direction Y. The first pixel region 71 in the pixel array unit 50c includes a pixel ring (first annular pixel region) 71C disposed on the outer peripheral side of the pixel array unit 50c. The pixel ring 71C includes the plurality of first pixels 52 annularly disposed along the first direction X and the second direction Y. The second pixel region 72 in the pixel array unit 50c is disposed in the entire region on an inner side from the first pixel region 71 (pixel ring 71C).

As described above, in the pixel array unit 50c described in the third embodiment, the first pixel region 71 (pixel ring 71C) is disposed so as to surround the second pixel region 72. As a result, in a case where the incident light from the object moves from the outside to the inside of the pixel array unit 50c, first, an event can be detected by the first pixel 52, and subsequently, the event can be detected by the second pixel 53, and performance of discrimination from the noise event can be improved. Furthermore, since the pixel ring 71C is disposed in the entire region on the outer peripheral side of the pixel array unit 50c, an event can be detected with uniform accuracy even if incident light enters the pixel array unit 50c from any direction.

### Fourth Embodiment

In a fourth embodiment, a third pixel that detects an event is newly provided in association with the second pixel 53 that has detected an event in the second pixel region 72.

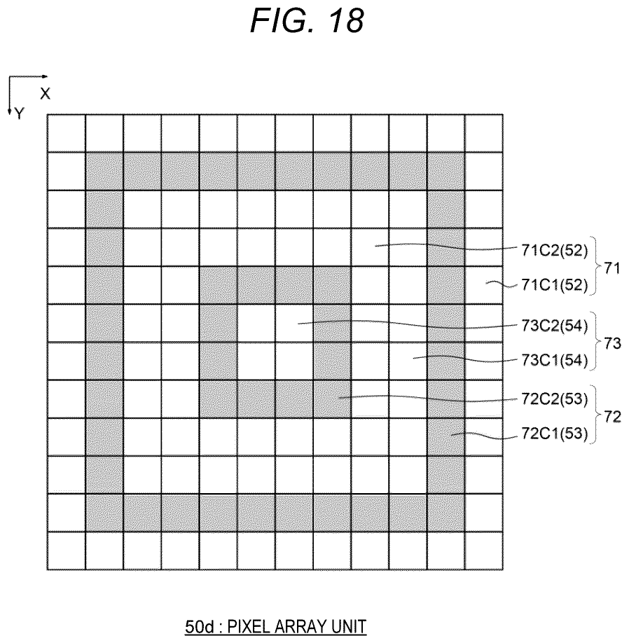

FIG. 18 is a plan view of a pixel array unit 50d in the fourth embodiment of the present disclosure. The pixel array unit 50d illustrated in FIG. 18 includes a third pixel region 73 in addition to the first pixel region 71 and the second pixel region 72. The third pixel region 73 is disposed in the vicinity of the second pixel region 72 and includes a third pixel 54 that performs detection of an event around the second pixel 53 in which the event is detected.

As in FIG. 17, the first pixel region 71 includes a pixel ring (first annular pixel region) 71C1 annularly disposed on the outer peripheral side of the pixel array unit 50d. The second pixel region 72 includes a pixel ring (second annular pixel region) 72C1 annularly disposed on an inner side from the pixel ring 71C1. The third pixel region 73 includes a pixel ring 73C1 annularly disposed on an inner side from the second pixel region 72.

Moreover, the first pixel region 71 includes a pixel ring (third annular pixel region) 71C2 annularly disposed on an inner side from the pixel ring 73C1. Furthermore, the second pixel region 72 includes a pixel ring 72C2 annularly disposed on an inner side from the pixel ring 71C2. Furthermore, the third pixel region 73 includes a pixel ring 73C2 annularly disposed on an inner side from the pixel ring 72C2.

Each of the pixel rings 71C1 and 71C2 in the first pixel region 71 includes a plurality of the first pixels 52 disposed in the first direction X and the second direction Y. Each of the pixel rings 72C1 and 72C2 in the second pixel region 72 includes a plurality of the second pixels 53 disposed in the first direction X and the second direction Y. Each of the pixel rings 73C1 and 73C2 in the third pixel region 73 includes a plurality of the third pixels 54 disposed in the first direction X and the second direction Y.

Each second pixel 53 in the pixel ring 72C1 is associated with any of the first pixels 52 in the pixel ring 71C1. One or more second pixels 53 in the pixel ring 72C1 that are associated with the first pixel 52 that has detected an event in the pixel ring 71C1 are enabled to detect the event. Each third pixel 54 in the pixel ring 73C1 is associated with any of the second pixels 53 in the pixel ring 72C1. One or more third pixels 54 in the pixel ring 73C1 that are associated with the second pixel 53 that has detected the event in the pixel ring 72C1 are enabled to detect the event.

Similarly, each second pixel 53 in the pixel ring 72C2 is associated with any of the first pixels 52 in the pixel ring 71C2. One or more second pixels 53 in the pixel ring 72C2 that are associated with the first pixel 52 that has detected the event in the pixel ring 71C2 are enabled to detect the event. Each third pixel 54 in the pixel ring 73C2 is associated with any of the second pixels 53 in the pixel ring 72C2. One or more third pixels 54 in the pixel ring 73C2 that are associated with the second pixel 53 that has detected the event in the pixel ring 72C2 are enabled to detect the event.

In the pixel array unit 50d in FIG. 18, the first pixel region 71 includes two pixel rings 71C1 and 71C2, the second pixel region 72 includes two pixel rings 72C1 and 72C2, and the third pixel region 73 includes two pixel rings 73C1 and 73C2, but the number of annular pixel regions provided in each pixel region is any number. Furthermore, the annular pixel regions do not necessarily have to be annular.

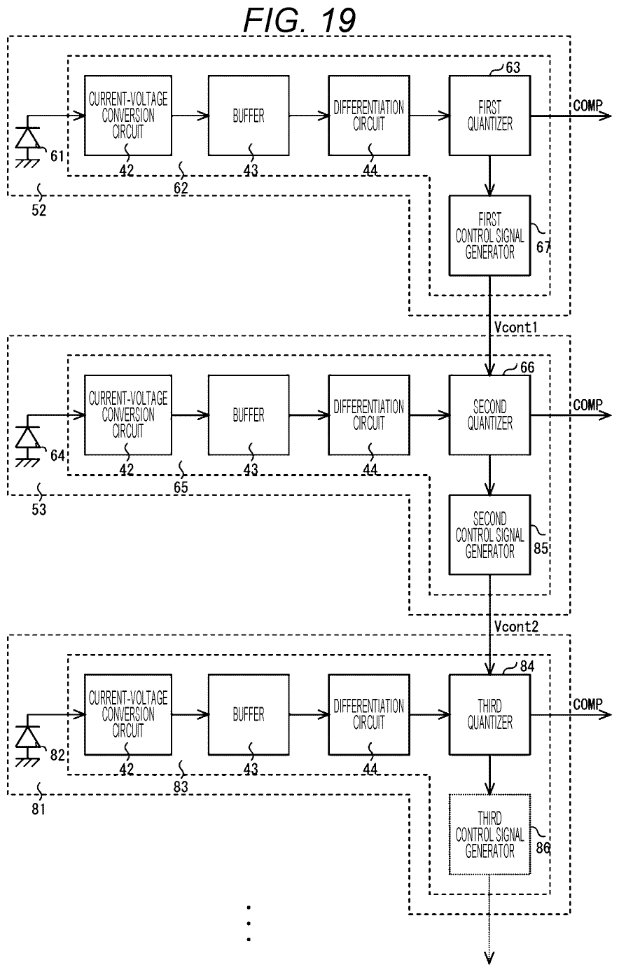

FIG. 19 is a block diagram illustrating an internal configuration of the first pixel 52, the second pixel 53, and the third pixel 54 in the fourth embodiment of the present disclosure. The internal configuration of the first pixel 52 is the same as that in FIG. 10. The second pixel 53 includes a second control signal generator 85 in addition to the internal configuration of the second pixel 53 in FIG. 10. The third pixel 54 includes a third photoelectric conversion element 82 and a third pixel circuit 83. The third pixel circuit 83 includes the current-voltage conversion circuit 42, the buffer 43, the differentiation circuit 44, and a third quantizer 84.

Similarly to FIG. 10, the second pixel circuit 65 detects an event only when the first control signal Vcont1 has the predetermined logic, and outputs the event detection signal COMP indicating a result of detection of the first event or the second event. The second control signal generator 85 sets a second control signal Vcont2 to predetermined logic when the first event or the second event is detected by the second pixel circuit 65. The third pixel circuit 83 detects the event on the basis of the photocharges accumulated in the third photoelectric conversion element 82 only when the second control signal Vcont2 in the second pixel 53 corresponding thereto is the predetermined logic.

The pixel array unit 50d may include a fourth pixel (not illustrated) associated with the third pixel 54. In this case, as indicated by a broken line in FIG. 19, a third control signal generator 86 needs to be provided in the third pixel 54. As described above, the pixel array unit 50 may be provided with any number of pixel regions greater than or equal to two including a pixel that enables detection of an event in a case where the event is detected in a pixel in another pixel region.

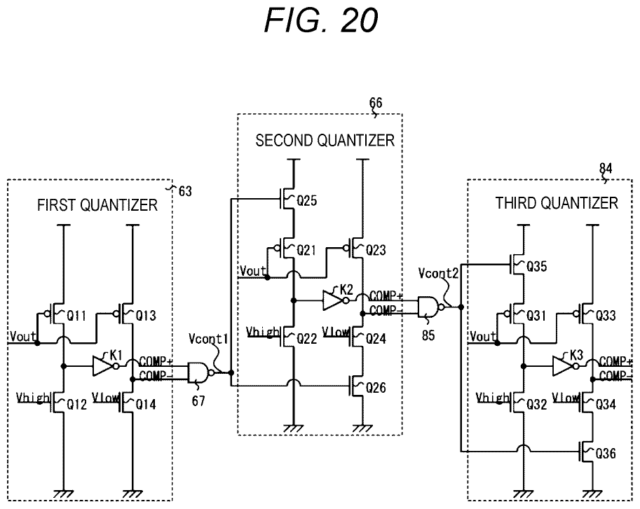

FIG. 20 is a circuit diagram of the first control signal generator 67, the second control signal generator 85, the first quantizer 63, the second quantizer 66, and the third quantizer 84 in the fourth embodiment of the present disclosure. The first quantizer 63 and the second quantizer 66 have a configuration similar to that in FIG. 11A. The third quantizer 84 includes an inverter K3. Furthermore, the third quantizer 84 includes transistors Q31 to Q36 respectively corresponding to the transistors Q21 to Q26 of the second quantizer 66.

The second control signal generator 85 includes, for example, a NAND circuit. The event detection signals COMP+ and COMP− output from the second quantizer 66 are input to the second control signal generator 85. The second control signal Vcont2 output from the second control signal generator 85 is input to the gates of the transistors Q35 and 036 of the third quantizer 84.

When the event detection signal COMP+ or COMP− at the low level is input from the second quantizer 66, the second control signal generator 85 outputs the second control signal Vcont2 at the high level. Similarly to the second quantizer 66, the third quantizer 84 can perform event detection when the second control signal Vcont2 at the high level is input, and outputs the event detection signals COMP+ and COMP− at the low level when the event is detected.

As described above, only in a case where the first pixel 52 has detected an event, the second pixel 53 associated with the first pixel 52 performs event detection. Furthermore, only in a case where both the first pixel 52 and the second pixel 53 have detected an event, the third pixel 54 associated with the second pixel 53 performs event detection.

As described above, in the fourth embodiment, the first pixel region 71, the second pixel region 72, and the third pixel region 73 are sequentially disposed in a ring shape from the outside to the inside of the pixel array unit 50d. As a result, in a case where the incident light travels from the outside to the inside of the pixel array unit 50d, it is possible to reliably detect the event based on the change in the amount of incident light and to further improve the performance of discrimination from the noise event. Note that the third pixel 54 in the fourth embodiment can also be applied in the first to second embodiments.

### Fifth Embodiment

In the pixel array unit 50 of the first to second embodiments, the first pixel region 71 and the second pixel region 72 are disposed adjacent to each other. On the other hand, in a fifth embodiment, an example will be described in which the first pixel region 71 and the second pixel region 72 are disposed apart from each other with a pixel other than the first pixel 52 and the second pixel 53 interposed therebetween.

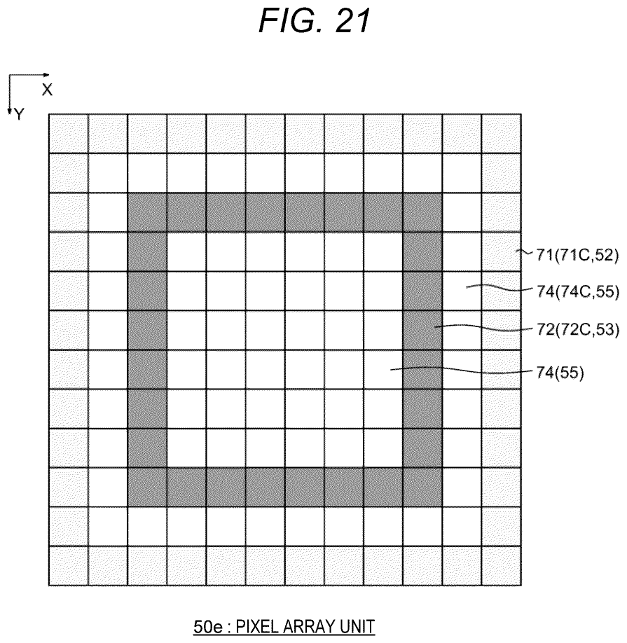

FIG. 21 is a plan view of a pixel array unit 50e in the fifth embodiment of the present disclosure. The pixel array unit 50e illustrated in FIG. 21 includes a pixel region 74 in addition to the first pixel region 71 and the second pixel region 72. The pixel region 74 includes a plurality of normal pixels 55. Each normal pixel 55 includes an event detection circuit having a configuration similar to that of the pixel 40 in FIG. 5A, for example, and detects an event based on the amount of change in the amount of incident light regardless of the event detection results in the first pixel region 71 and the second pixel region 72. The normal pixel 55 may be a gradation pixel that outputs a pixel signal including gradation information on a single color or a plurality of colors in accordance with the amount of incident light.

The first pixel region 71 includes the pixel ring 71C annularly disposed on the outer peripheral side of the pixel array unit 50e. The second pixel region 72 includes a pixel ring 72C annularly disposed on an inner side from the first pixel region 71. The pixel region 74 is annularly disposed (a pixel ring 74C) between the first pixel region 71 and the second pixel region 72, and is also disposed in the entire region on an inner side from the second pixel region 72.

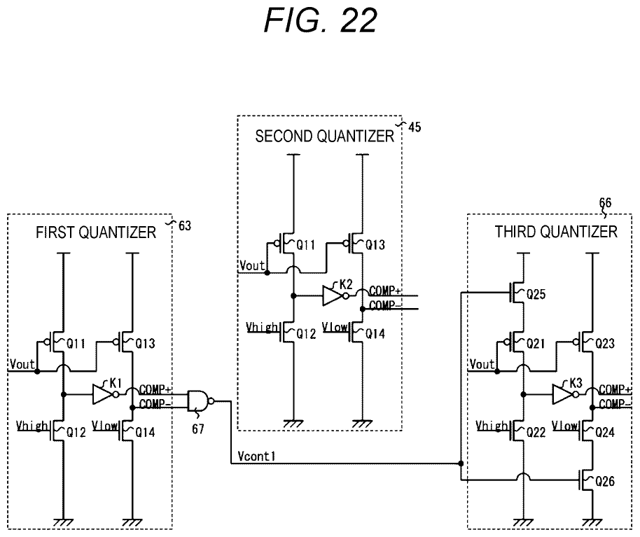

FIG. 22 is a circuit diagram illustrating a part of an internal configuration of the first pixel 52, the normal pixel 55, and the second pixel 53 in the fifth embodiment of the present disclosure. FIG. 22 illustrates the first quantizer 63 in the first pixel 52, the quantizer 45 in the normal pixel 55, the second quantizer 66 in the second pixel 53, and the first control signal generator 67. The first control signal Vcont1 output from the first control signal generator 67 is not input to the quantizer 45 in the normal pixel 55, but is input to the second quantizer 66 in the second pixel 53. Thus the normal pixel 55 detects the event based on the amount of change in the amount of incident light regardless of whether or not the first pixel 52 detects the event.

As described above, in the pixel array unit 50e in the fifth embodiment, the first pixel region 71 and the second pixel region 72 are disposed apart from each other with the normal pixel 55 interposed therebetween. As a result, even in a case where the incident light moves at a high speed or in a case where a delay in transmission of the first control signal Vcont1 occurs between the first pixel 52 and the second pixel 53, an event is easily detected in both the first pixel 52 and the second pixel 53, and high-speed tracking of the event can be improved. Similarly, the second pixel region 72 and the third pixel region 73 may be disposed apart from each other with the normal pixel 55 interposed therebetween.

### Sixth Embodiment

In the first to fifth embodiments, an example has been described in which sizes of the first pixel 52 and the second pixel 53 are the same, but the sizes of the first pixel 52 and the second pixel 53 may be different from each other. For example, the size of the first pixel 52 may be made larger than the size of the second pixel 53.

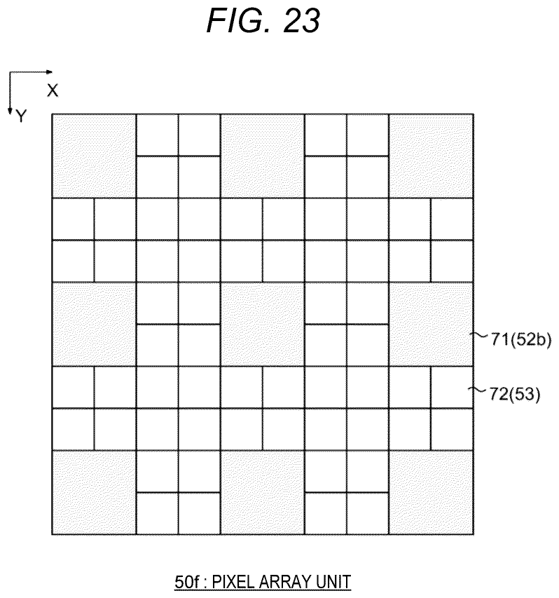

FIG. 23 is a plan view of a pixel array unit 50f in a sixth embodiment of the present disclosure. The pixel array unit 50f illustrated in FIG. 23 includes a plurality of first pixels 52b. The size of the first pixel 52b is made larger than the size of the second pixel 53. As a result, event detection sensitivity in the first pixel 52b can be improved. By determining that an event is detected only in a case where the event is detected in the first pixel 52b and then the event is detected in the second pixel 53 smaller in size than the first pixel 52b, it is possible to improve the performance of discrimination from the noise event. Note that FIG. 23 illustrates an example in which the size of the first pixel 52b is four times the size of the second pixel 53, but any size ratio is adopted.

As described above, in the pixel array unit 50f in the sixth embodiment, the sizes of the first pixel 52b and the second pixel 53 are made different from each other. The sizes of the first pixel 52 and the second pixel 53 can be optimized in accordance with a type of an event desired to be detected, surrounding brightness, the number of noise events, or the like.

### Seventh Embodiment

According to the first to sixth embodiments, the event detection sensitivity of the pixel 40 can be increased, and detection of a noise event can be reduced. The pixel 40 can adjust the event detection sensitivity by adjusting the threshold voltages Vhigh and Vlow. The threshold voltages Vhigh and Vlow may be adjusted on the basis of the number of detected events. As a result, the threshold voltages Vhigh and Vlow can be adjusted so that a certain number of detected events is obtained.

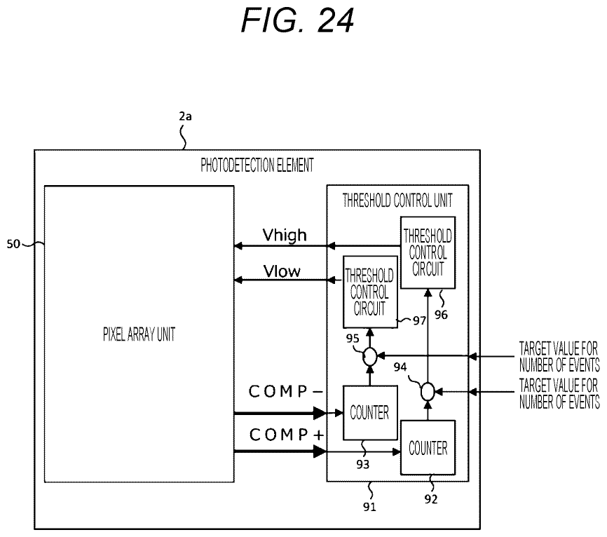

FIG. 24 is a block diagram illustrating a schematic configuration of the photodetection element 2 in a seventh embodiment of the present disclosure. A photodetection element 2a illustrated in FIG. 24 includes a threshold control unit 91. The photodetection element 2a includes a signal processing circuit and the like in addition to the pixel array unit 50 and the threshold control unit 91 illustrated in FIG. 24, but those are not illustrated in FIG. 24.

The threshold control unit 91 controls a level of the threshold in accordance with at least one of the number of first pixels 52 in which an event is detected among a plurality of the first pixels 52 or the number of second pixels 53 in which an event is detected among a plurality of the second pixels 53. The threshold control unit 91 includes a counter 92, a counter 93, a difference detector 94, a difference detector 95, a threshold control circuit 96, and a threshold control circuit 97. Note that the threshold control unit 91 may control the voltage level of the threshold in accordance with the number of the third pixels 54 in which an event is detected among a plurality of the third pixels 54, or may control the voltage level of the threshold in accordance with the number of the normal pixels 55 in which an event is detected among a plurality of the normal pixels 55.

The event detection signal COMP+ output from each pixel 40 in the pixel array unit 50 is input to the counter 92. The counter 92 counts, for example, ones at the low level among the event detection signals COMP+, and supplies a counted value to the difference detector 94 as a count value of the first event.

To the difference detector 94, the count value of the first event is supplied from the counter 92, and a target value for the number of events of the first event is supplied from the outside of the photodetection element 2a. The difference detector 94 compares the count value of the first event with the target value for the number of events of the first event, and supplies a difference value of the count value of the first event with respect to the target value to the threshold control circuit 96.

The threshold control circuit 96 adjusts the threshold value Vhigh of each pixel 40 on the basis of the difference value of the count value of the first event with respect to the target value, received from the difference detector 94. For example, in a case where the count value of the first event is smaller than the target value for the number of events of the first event, the threshold control circuit 96 increases the threshold value Vhigh to increase the number of detected first events in each pixel 40. Furthermore, in a case where the count value of the first event is larger than the target value for the number of events of the first event, the threshold control circuit 96 decreases the threshold Vhigh to decrease the number of detected first events in each pixel 40. The threshold control circuit 96 adjusts the threshold Vhigh of each pixel 40 to increase or decrease the number of detected first events, thereby bringing the number of detected first events closer to the target value for the number of events.

The counter 93, the difference detector 95, and the threshold control circuit 97 perform, for the second event, processing similar to that by the counter 92, the difference detector 94, and the threshold control circuit 96. Specifically, the event detection signal COMP− output from each pixel 40 is input to the counter 93. The counter 93 supplies a count value of the second event to the difference detector 95. A target value for the number of events of the second event is supplied to the difference detector 95. The difference detector 95 compares the count value of the second event with the target value for the number of events of the second event. The threshold control circuit 97 adjusts the threshold Vlow of each pixel 40 on the basis of a comparison result by the difference detector 95. In a case where the count value of the second event is smaller than the target value for the number of events of the second event, the threshold value Vlow of each pixel 40 is decreased. In a case where the count value of the second event is larger than the target value for the number of events of the second event, the threshold control circuit 97 increases the threshold value Vlow of each pixel 40. The threshold control circuit 97 adjusts the threshold Vlow to bring the number of detected second events closer to the target value for the number of events.

As described above, the photodetection element 2a counts the number of detected events after taking measures for the noise event by the methods described in the first to sixth embodiments, and adjusts the threshold used in the quantizer 45 on the basis of the count value. As a result, the number of detected events can be adjusted to a desired value, and signal processing in the subsequent stage can be easily performed.

### Eighth Embodiment

The second pixel 53 in the first to second embodiments is set to a state of being capable of event detection only in a case where the first pixel 52 corresponding thereto has detected the event. On the other hand, the second pixel 53 may be made to arbitrarily switch to any one of a mode in which the event can be always detected, or a mode in which the event can be detected only in a case where the first pixel corresponding thereto has detected the event as described above.

FIG. 25 is a block diagram of the first pixel 52 and the second pixel 53 in an eighth embodiment of the present disclosure. The first pixel circuit 62 in FIG. 25 includes a pixel operation switcher 101. The first control signal generator 67 in FIG. 25 outputs the first control signal Vcont1 of predetermined logic (for example, high level) separately from the event detection signal COMP when an event is detected or when the pixel operation switcher 101 is in a predetermined state (for example, off state).

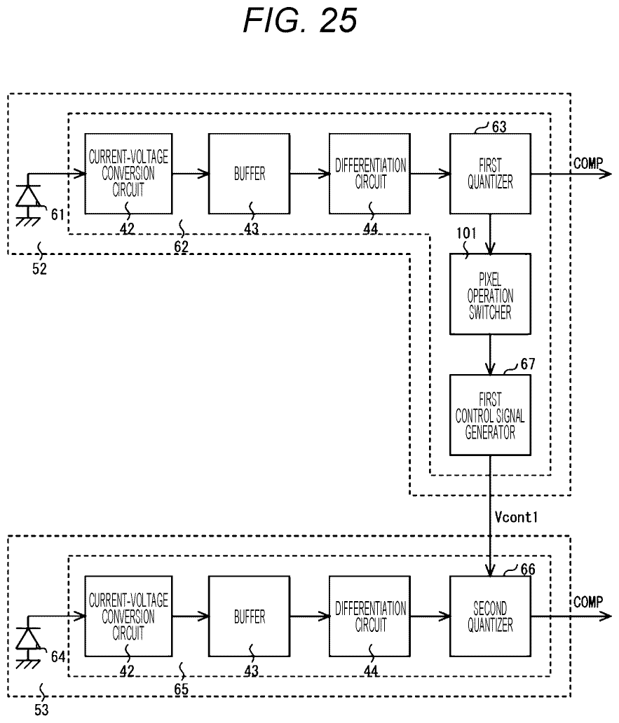

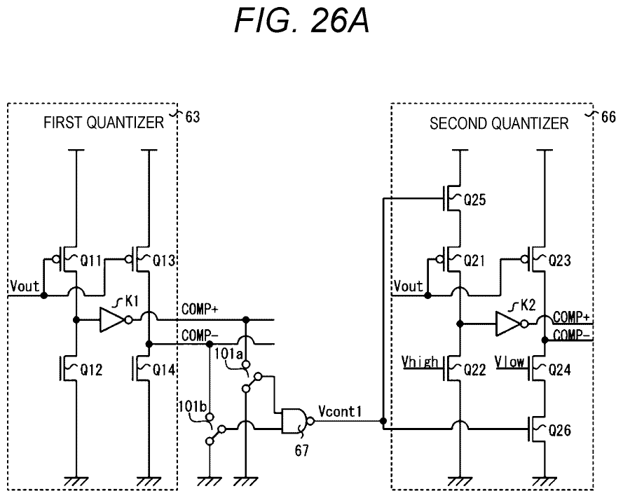

FIGS. 26A and 26B are circuit diagrams of the first control signal generator 67, the pixel operation switcher 101, the first quantizer 63, and the second quantizer 66 in the eighth embodiment of the present disclosure. The pixel operation switcher 101 in FIGS. 26A and 26B includes two switches 101a and 101b. One end of each of the switches 101a and 101b is connected to the first control signal generator 67.

FIG. 26A is a circuit diagram when the pixel operation switcher 101 is in the off state. The first control signal generator 67 in FIG. 26A is connected to the reference voltage (ground) node via the switch 101a and is connected to the reference voltage (ground) node via the switch 101b. Off-level signals are input to the first control signal generator 67 via the switches 101a and 101b, respectively. As a result, the first control signal generator 67 outputs the first control signal Vcont1 at the high level regardless of a signal level of the event detection signal COMP of the first quantizer 63.

FIG. 26B is a circuit diagram when the pixel operation switcher 101 is in the on state. The first control signal generator 67 in FIG. 26B is connected to the inverter K1 via the switch 101a and is connected to the drain of the transistor Q13 via the switch 101b. To the first control signal generator 67, the event detection signal COMP+ is input via the switch 101a, and the event detection signal COMP− is input via the switch 101b. As a result, the first control signal generator 67 outputs the first control signal Vcont1 at the high level when an event is detected in the first pixel 52 as in FIG. 11A.

The first control signal generator 67 illustrated in FIGS. 26A and 26B outputs the first control signal Vcont1 at the high level when an event is detected or when the switches 101a and 101b are in the off states.

As described above, in the eighth embodiment, the first pixel circuit 62 includes the pixel operation switcher 101. When the pixel operation switcher 101 is in the off state, for example, the second pixel 53 detects an event regardless of whether or not the first pixel 52 detects an event. When the pixel operation switcher 101 is in the on state, for example, the second pixel 53 detects an event after the first pixel 52 detects the event. By the pixel operation switcher 101, it is possible to switch whether the second pixel 53 is associated with the first pixel 52 or an event is always detected similarly to the pixel 40 in FIG. 5A. The pixel operation switcher 101 can be applied to any of the first to seventh embodiments. As a result, an event can be detected in all the pixels in the first pixel region 71 and the second pixel region 72, as necessary.

### Ninth Embodiment

In the first to seventh embodiments, whether or not an event is detected in the second pixel region is switched on the basis of the event detection result in the first pixel region. A ninth embodiment is characterized by that, with a pixel group including two or more pixels in the pixel array unit 50 as a unit, any one of the pixels in the pixel group is used as the first pixel 52 and the remaining pixels 40 are used as the second pixels 53 for each pixel group, and the first pixel 52 in the pixel group can be changed, as necessary.

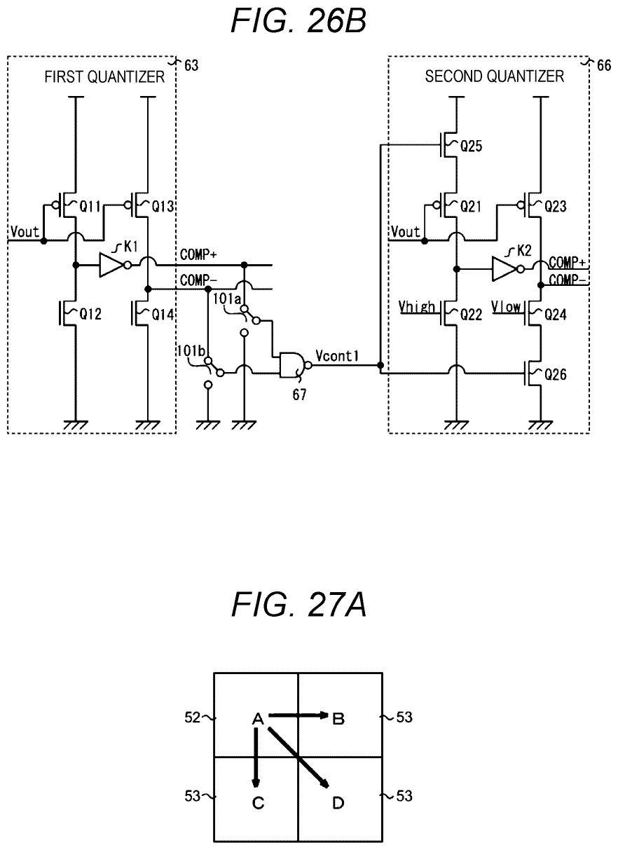

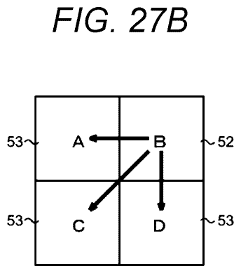

FIG. 27A is a diagram illustrating an example in which a pixel A among pixels A, B, C, and D constituting a pixel group is set as the first pixel 52, and the pixels B, C, and D are set as the second pixels 53. That is, the pixels B, C, and D can detect an event only in a case where the pixel A detects the event.

On the other hand, FIG. 27B is a diagram illustrating an example in which the pixel B among the pixels A, B, C, and D constituting the pixel group is set as the first pixel 52, and the pixels A, C, and D are set as the second pixels 53. That is, the pixels A, C, and D can detect an event only in a case where the pixel B detects the event.

As described above, in the pixel array unit 50 in the ninth embodiment, for each pixel group including two or more pixels 40, one of the pixels in the pixel group is set as the first pixel 52, and the remaining pixels are set as the second pixels 53. The first pixel 52 of each pixel group can be switched, as necessary. Hereinafter, a specific configuration for implementing FIGS. 27A and 27B will be described.

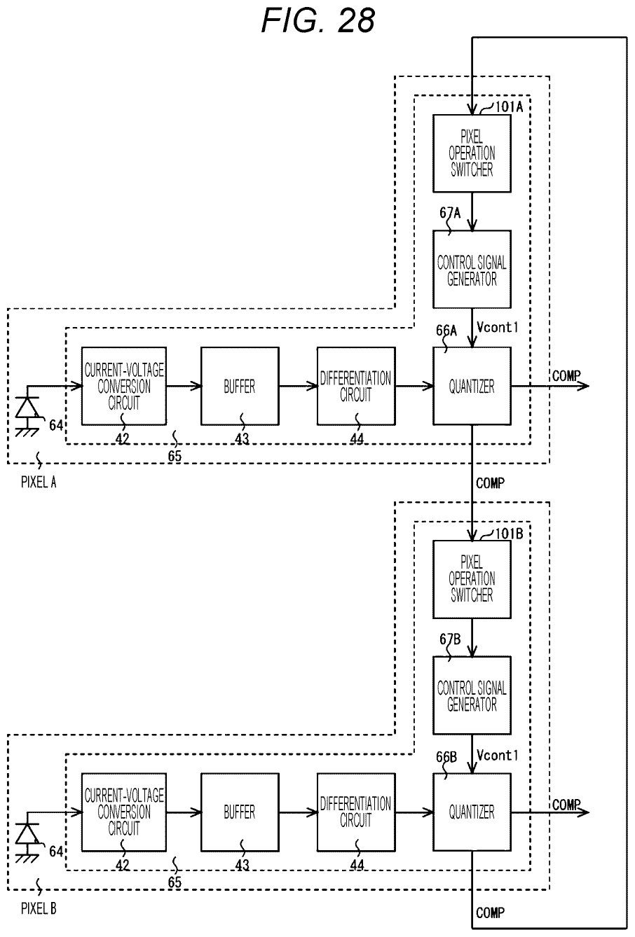

FIG. 28 is a block diagram of two pixels A and B included in one pixel group in the ninth embodiment of the present disclosure. The number of pixels constituting the pixel group is any number, and pixels other than the pixels A and B may be included in the pixel group. Both the pixel A and the pixel B have the same block configuration. That is, both the pixel A and the pixel B include the current-voltage conversion circuit 42, the buffer 43, and the differentiation circuit 44. Furthermore, the pixel A and the pixel B include quantizers 66A and 66B, pixel operation switchers 101A and 101B, and control signal generators 67A and 67B, having the same configurations, respectively.

In FIG. 25, whether or not to perform event detection in the second pixel 53 is switched by the first control signal Vcont1 output from the first control signal generator 67 in the first pixel 52. On the other hand, the pixel operation switchers 101A and 101B in FIG. 28 can arbitrarily switch whether to use the pixels A and B as the first pixel 52 or the second pixel 53.

In FIG. 25, the pixel operation switcher 101 and the first control signal generator 67 are disposed on the subsequent stage side of the first quantizer 63 in the first pixel 52, but in FIG. 28, the control signal generators 67A and 67B and the pixel operation switchers 101A and 101B are disposed on the preceding stage side of the quantizers 45A and 45B of respective pixels.

The control signal generator 67A in the pixel A inputs the first control signal Vcont1 according to switching of the pixel operation switcher 101A to the quantizer 66A in the pixel A. The event detection signal COMP output from the quantizer 66A is transmitted to a subsequent circuit and is input to the pixel operation switcher 101B in the pixel B. Similarly, the control signal generator 67B in the pixel B inputs the first control signal Vcont1 according to switching of the pixel operation switcher 101B to the quantizer 66B in the pixel B. The event detection signal COMP output from the quantizer 66B is transmitted to a subsequent circuit and is input to the pixel operation switcher 101A in the pixel A. In a case where the quantizers 66A and 66B detect polarity of the event, the quantizers 66A and 66B output the event detection signals COMP+ and COMP−.

Switching of the pixel operation switcher 101A in the pixel A and switching of the pixel operation switcher 101B in the pixel B are performed in synchronization, whereby one of the pixel A and the pixel B operates as the first pixel 52 and the other operates as the second pixel 53.

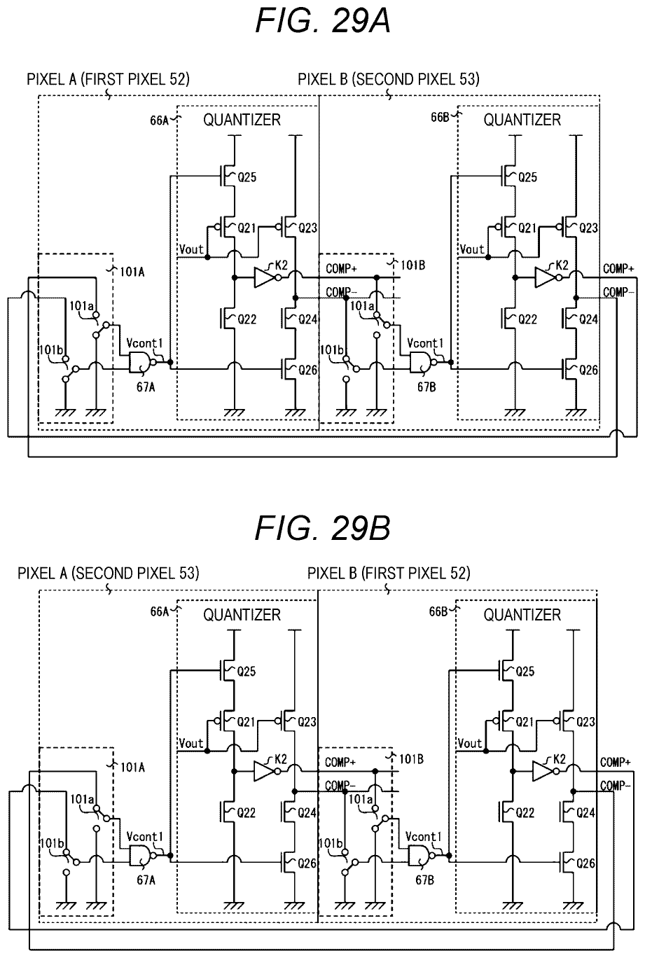

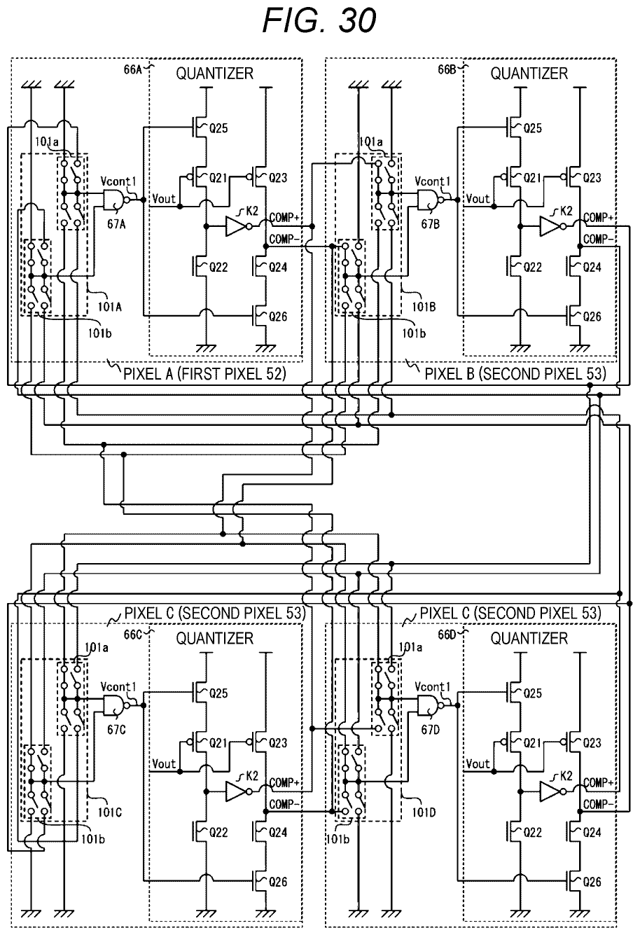

FIG. 29A is a circuit diagram of the quantizers 66A and 66B, the pixel operation switchers 101A and 101B, and the control signal generators 67A and 67B in the pixels A and B in a case where the pixel A is operated as the first pixel 52 and the pixel B is operated as the second pixel 53.

The switches 101a and 101b in the pixel operation switcher 101B in the pixel B input the event detection signals COMP+ and COMP− output from the quantizer 66A of the pixel A to two input nodes of the NAND circuit of the control signal generator 67B. As a result, the first control signal Vcont1 output from the control signal generator 67B is at the high level when any of the event detection signals COMP+ and COMP− is at the low level. The quantizer 66B in the pixel B can detect an event only in a case where the event is detected in the pixel A. That is, the pixel B operates as the second pixel 53.

On the other hand, the switches 101a and 101b in the pixel operation switcher 101A in the pixel A are connected to the ground node side, and two input nodes of the NAND circuit of the control signal generator 67A is at the low level. Thus, the first control signal Vcont1 output from the control signal generator 67A in the pixel A is at the high level regardless of whether or not an event is detected in the pixel B. Thus, the pixel A can always detect an event. That is, the pixel A operates as the first pixel 52.

FIG. 29B is a circuit diagram of the quantizers 66A and 66B, the pixel operation switchers 101A and 101B, and the control signal generators 67A and 67B in a case where the pixel B is operated as the first pixel 52 and the pixel A is operated as the second pixel 53.

The switches 101a and 101b in the pixel operation switcher 101A in the pixel A input the event detection signals COMP+ and COMP− output from the quantizer 66B of the pixel B to two input nodes of the NAND circuit of the control signal generator 67A. As a result, the first control signal Vcont1 output from the control signal generator 67A is at the high level when any of the event detection signals COMP+ and COMP− is at the low level. The quantizer 66A in the pixel A can detect an event only in a case where the event is detected in the pixel B. That is, the pixel A operates as the second pixel 53.

On the other hand, the switches 101a and 101b in the pixel operation switcher 101B in the pixel B are connected to the ground node side, and two input nodes of the NAND circuit of the control signal generator 67B are at the low level. Thus, the first control signal Vcont1 output from the control signal generator 67B in the pixel B is at the high level regardless of whether or not an event is detected in the pixel A. Thus, the pixel B can always detect an event. That is, the pixel B operates as the first pixel 52.

FIG. 30 is a circuit diagram for implementing FIG. 27A. FIG. 30 illustrates quantizers 66A, 66B, 66C, and 66D, control signal generators 67A, 67B, 67C, and 67D, and pixel operation switchers 101A, 101B, 101C, and 101D in respective pixel circuits of the pixels A, B, C, and D.

In FIG. 30, similarly to FIG. 28, the control signal generators 67A to 67D and the pixel operation switchers 101A to 101D are disposed on the preceding stage side of the quantizers 66A to 66D of respective pixels. The control signal generators 67A to 67D and the pixel operation switchers 101A to 101D can arbitrarily switch whether to use the pixels A to D as the first pixel 52 or the second pixel 53.

Each of the pixel operation switchers 101A to 101D includes two switches 101a and 101b. One ends of the switches 101a and 101b in the pixel operation switchers 101A to 101D are connected to the NAND circuits in the control signal generators 67A to 67D.

In FIG. 30, the switches 101a and 101b in the pixel operation switcher 101A of the pixel A are connected to the ground node side. As a result, the output of the NAND circuit has the high level, and the quantizer 66A can always detect an event. That is, the pixel A operates as the first pixel 52.

On the other hand, the switches 101a and 101b in the pixel operation switchers 101B to 101D of the pixels B to D input the event detection signals COMP+ and COMP− output from the quantizer 45A to two input nodes of the NAND circuit of the control signal generators 67B to 67D. As a result, only in a case where the quantizer 66A detects an event, the output of the NAND circuit has the high level, and the quantizers 66B to 66D can detect the event. That is, the pixels B to D operate as the second pixels 53.

Furthermore, it is also possible to implement FIG. 27B by the quantizers 66A to 66D in FIG. 30. That is, it is also possible to set the pixel B as the first pixel 52, and set the remaining three pixels A, C, and D as the second pixel 53. In that case, it is necessary to connect the switches 101a and 101b in the pixel operation switcher 101B to the ground node side. Furthermore, the switches 101a and 101b in the pixel operation switchers 101A, 101C, and 101D need to input the event detection signals COMP+ and COMP− output from the quantizer 66B to two input nodes of the NAND circuits of the control signal generators 67A, 67C, and 67D. Similarly, it is also possible for the pixel C or D to be the first pixel 52.

As described above, in the ninth embodiment, for each pixel group including two or more pixels 40 in the pixel array unit 50, any one pixel in the pixel group can be set as the first pixel 52 and the remaining pixel can be set as the second pixel 53, so that it is possible to arbitrarily set which pixel 40 first detects an event. As a result, pixel positions of the first pixel 52 and the second pixel 53 can be flexibly adjusted in accordance with a moving direction of the incident light.

### Application Example

The technology according to the present disclosure can be applied to various products. For example, the technology according to the present disclosure may also be implemented as a device mounted on any type of mobile body such as an automobile, an electric automobile, a hybrid electric automobile, a motorcycle, a bicycle, a personal mobility, an airplane, a drone, a ship, a robot, a construction machine, or an agricultural machine (tractor).

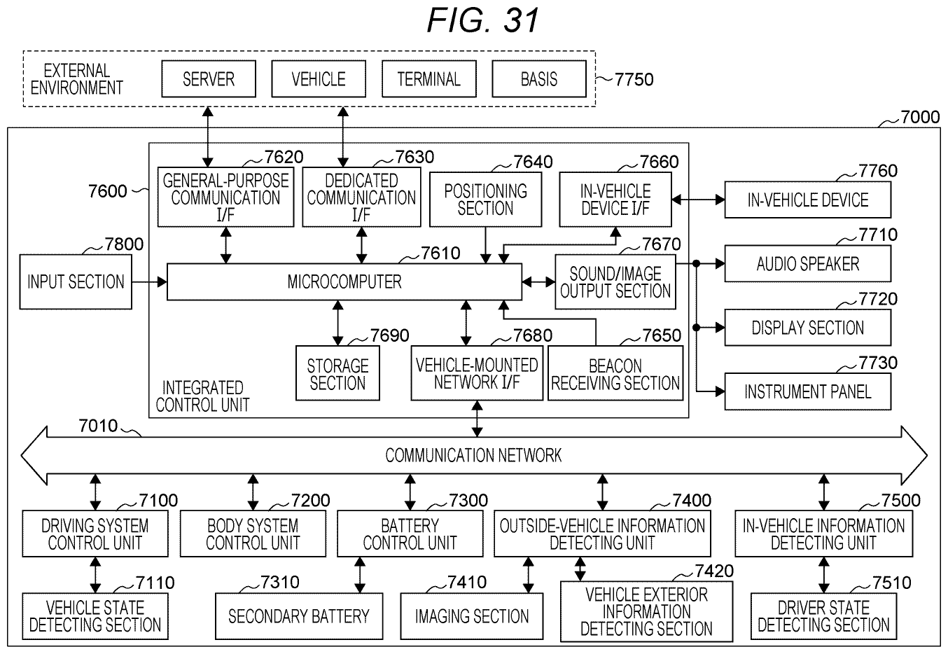

FIG. 31 is a block diagram illustrating an example of a schematic configuration of a vehicle control system 7000 as an example of a mobile body control system to which the technology according to the present disclosure can be applied. The vehicle control system 7000 includes a plurality of electronic control units connected to each other via a communication network 7010. In the example illustrated in FIG. 31, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. As a functional configuration of the integrated control unit 7600, FIG. 31 illustrates a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

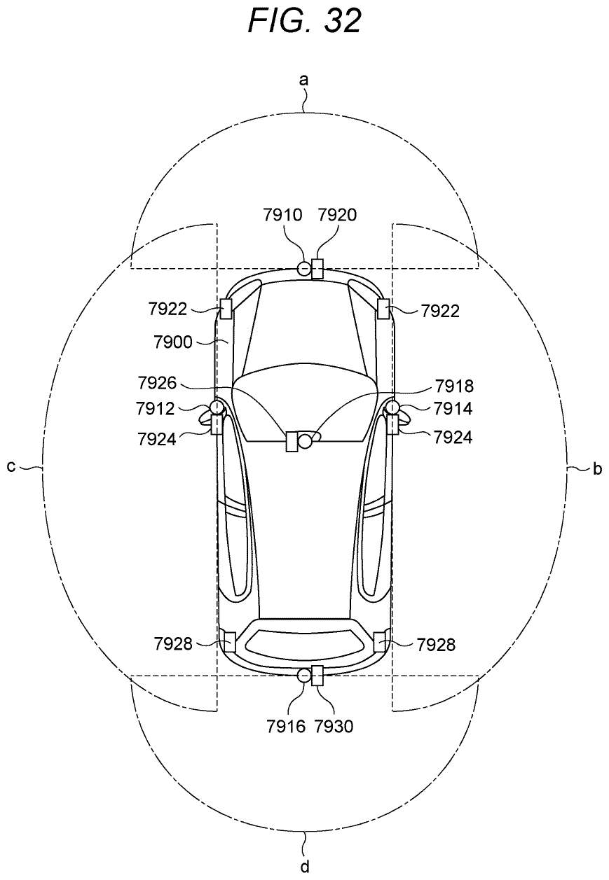

Here, FIG. 32 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 32 illustrates an example of imaging ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 31, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 31, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that at least two control units connected to each other via the communication network 7010 in the example illustrated in FIG. 31 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that the present technology can have the following configurations.
(1) A photodetection element including:
a first pixel region including a plurality of first pixels each performing detection of an event based on an amount of change of an amount of incident light; and
a second pixel region disposed in the vicinity of the first pixel region and including a second pixel that performs detection of the event around a first pixel in which the event is detected among the plurality of first pixels.
(2) The photodetection element according to (1), in which one or more of the second pixels in the second pixel region are associated with one of the first pixels in the first pixel region, and
detection of the event is performed in all of the second pixels corresponding to the first pixel in which the event is detected.
(3) The photodetection element according to (1) or (2), in which
the plurality of first pixels in the first pixel region is disposed apart from each other with a pixel other than the first pixel interposed therebetween in a first direction and a second direction intersecting each other.
(4) The photodetection element according to (3), in which
the pixel other than the first pixel includes the second pixel.
(5) The photodetection element according to (1) or (2), in which
the plurality of first pixels in the first pixel region is disposed in a first annular pixel region extending in a first direction and a second direction intersecting each other.
(6) The photodetection element according to (5), further including
a pixel array unit including the first pixel region and the second pixel region and extending in the first direction and the second direction, in which
the first annular pixel region is disposed on an outer peripheral side of the pixel array unit.
(7) The photodetection element according to (6), in which
the second pixel in the second pixel region is disposed on an inner side from the first annular pixel region in the pixel array unit.
(8) The photodetection element according to (6) or (7), in which
the second pixel in the second pixel region is disposed in a second annular pixel region on an inner side from the first annular pixel region in the pixel array unit.
(9) The photodetection element according to (8), further including
a third annular pixel region that is disposed on a further inner side from the second annular pixel region of the pixel array unit and in which two or more of the first pixels are disposed.
(10) The photodetection element according to (3), further including
a pixel array unit including the first pixel region and the second pixel region and extending in the first direction and the second direction, in which
the plurality of first pixels in the first pixel region is disposed along a plurality of lines extending in the first direction or the second direction.
(11) The photodetection element according to (10), in which
the second pixel in the second pixel region is disposed between the plurality of lines along a direction in which the plurality of lines extends.
(12) The photodetection element according to any one of (1) to (11), further including
a third pixel region disposed in the vicinity of the second pixel region and including a third pixel that performs detection of the event around the second pixel in which the event is detected.
(13) The photodetection element according to any one of (1) to (12), in which
a size of the first pixel is larger than a size of the second pixel.
(14) The photodetection element according to any one of (1) to (13), in which
the first pixel includes
a first photoelectric conversion element that accumulates charges corresponding to an amount of incident light, and
a first pixel circuit that detects the event on the basis of the charges,
the first pixel circuit includes a first control signal generator that outputs a first control signal of predetermined logic separately from a detection signal of the event when the event is detected, and
the second pixel includes
a second photoelectric conversion element that accumulates charges corresponding to an amount of incident light, and
a second pixel circuit that detects the event on the basis of the charges accumulated in the second photoelectric conversion element only when the first control signal in the first pixel corresponding to the second pixel is the predetermined logic.
(15) The photodetection element according to (14), in which
the second pixel circuit includes:
a charge-voltage conversion circuit that converts the charges accumulated in the second photoelectric conversion element into a voltage;
a differentiation circuit that generates a differential signal corresponding to a change in the voltage converted by the charge-voltage conversion circuit; and
a quantizer that generates a detection signal of the event on the basis of a result of performing a comparison operation of comparing a signal level of the differential signal with a threshold, and
the quantizer performs the comparison operation only when the first control signal in the first pixel corresponding to the second pixel has the predetermined logic.
(16) The photodetection element according to (15), further including
a threshold control unit that controls a voltage level of the threshold in accordance with at least one of the number of the first pixels in which the event is detected among a plurality of the first pixels and the number of the second pixels in which the event is detected among a plurality of the second pixels.
(17) The photodetection element according to any one of (14) to (16), in which
the first pixel circuit outputs a first event in which a change from a low state to a high state of an amount of incident light is detected or a second event in which a change from a high state to a low state of an amount of incident light is detected, and
the first control signal generator sets the first control signal to the predetermined logic when the first event or the second event is output from the first pixel circuit.
(18) The photodetection element according to any one of (14) to (17), in which
the first pixel circuit includes a pixel operation switcher that causes the first control signal generator to output the first control signal of the predetermined logic regardless of whether or not the event is detected in the first pixel circuit, or causes the first control signal generator to output the first control signal of the predetermined logic only when the event is detected in the first pixel circuit.
(19) The photodetection element according to any one of (6) to (11), in which
each of pixels in the pixel array unit includes, with a pixel group including two or more pixels in the pixel array unit as a unit, a pixel operation switcher to cause any one pixel in the pixel group to be the first pixel and remaining pixels to be the second pixel.
(20) An electronic device including:
a photodetection element that outputs image data; and
a recording unit that records the image data, in which
the photodetection element includes:
a first pixel region including a plurality of first pixels each performing detection of an event based on an amount of change of an amount of incident light; and
a second pixel region disposed in the vicinity of the first pixel region and including a second pixel that performs detection of the event around a first pixel in which the event is detected among the plurality of first pixels.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Electronic device
2, 2a Photodetection element
3 Recording unit
4 Control unit
11 Imaging lens
12 Signal line
13 Control line
21 Light receiving chip
22 Detection chip
23 Via arrangement section
24 Light receiving section
31 Photoelectric conversion element
32 Event detection section
33 Row drive circuit
34 Column drive circuit
35 Signal processing circuit
40 Pixel
41, 41a Event detection circuit
42 Current-voltage conversion circuit
43 Buffer
44 Differentiation circuit
45, 45a Quantizer
46 Logarithmic response unit
50, 50a, 50b, 50c, 50d, 50e, 50f Pixel array unit
51 Noise event
52, 52a, 52b First pixel
52Lx, 53Lx Pixel row
52Ly, 53Ly Pixel column
53, 53a Second pixel
54 Third pixel
55 Normal pixel
61 First photoelectric conversion element
62 First pixel circuit
63, 63a First quantizer
64 Second photoelectric conversion element
65 Second pixel circuit
66, 66a Second quantizer
66A, 66B, 66C, 66D Quantizer
67, 67a, 67A, 67B, 67C, 67D Control signal generator
71 First pixel region
71C, 71C1, 71C2, 72C, 72C1, 72C2, 73C1, 73C2, 74C Pixel ring
72 Second pixel region
73 Third pixel region
74 Pixel region
82 Third photoelectric conversion element
83 Third pixel circuit
84 Third quantizer
85 Second control signal generator
86 Third control signal generator
91 Threshold control unit
92, 93 Counter
94, 95 Difference detector
96, 97 Threshold control circuit
101, 101A, 101B, 101C, 101D Pixel operation switcher
101a, 101b Switch

What is claimed is:

1. A photodetection element comprising:
a first pixel region including a plurality of first pixels each performing detection of an event based on an amount of change of an amount of incident light; and
a second pixel region disposed in a vicinity of the first pixel region and including a second pixel that performs detection of the event around a first pixel in which the event is detected among the plurality of first pixels.

2. The photodetection element according to claim 1, wherein
one or more of the second pixels in the second pixel region are associated with one of the first pixels in the first pixel region, and
detection of the event is performed in all of the second pixels corresponding to the first pixel in which the event is detected.

3. The photodetection element according to claim 1, wherein
the plurality of first pixels in the first pixel region is disposed apart from each other with a pixel other than the first pixel interposed therebetween in a first direction and a second direction intersecting each other.

4. The photodetection element according to claim 3, wherein
the pixel other than the first pixel includes the second pixel.

5. The photodetection element according to claim 1, wherein
the plurality of first pixels in the first pixel region is disposed in a first annular pixel region extending in a first direction and a second direction intersecting each other.

6. The photodetection element according to claim 5, further comprising
a pixel array unit including the first pixel region and the second pixel region and extending in the first direction and the second direction, wherein
the first annular pixel region is disposed on an outer peripheral side of the pixel array unit.

7. The photodetection element according to claim 6, wherein
the second pixel in the second pixel region is disposed on an inner side from the first annular pixel region in the pixel array unit.

8. The photodetection element according to claim 6, wherein
the second pixel in the second pixel region is disposed in a second annular pixel region on an inner side from the first annular pixel region in the pixel array unit.

9. The photodetection element according to claim 8, further comprising
a third annular pixel region that is disposed on a further inner side from the second annular pixel region of the pixel array unit and in which two or more of the first pixels are disposed.

10. The photodetection element according to claim 3, further comprising
a pixel array unit including the first pixel region and the second pixel region and extending in the first direction and the second direction, wherein
the plurality of first pixels in the first pixel region is disposed along a plurality of lines extending in the first direction or the second direction.

11. The photodetection element according to claim 10, wherein
the second pixel in the second pixel region is disposed between the plurality of lines along a direction in which the plurality of lines extends.

12. The photodetection element according to claim 1, further comprising
a third pixel region disposed in a vicinity of the second pixel region and including a third pixel that performs detection of the event around the second pixel in which the event is detected.

13. The photodetection element according to claim 1, wherein
a size of the first pixel is larger than a size of the second pixel.

14. The photodetection element according to claim 1, wherein
the first pixel includes
a first photoelectric conversion element that accumulates charges corresponding to an amount of incident light, and
a first pixel circuit that detects the event on a basis of the charges,
the first pixel circuit includes a first control signal generator that outputs a first control signal of predetermined logic separately from a detection signal of the event when the event is detected, and
the second pixel includes
a second photoelectric conversion element that accumulates charges corresponding to an amount of incident light, and
a second pixel circuit that detects the event on a basis of the charges accumulated in the second photoelectric conversion element only when the first control signal in the first pixel corresponding to the second pixel is the predetermined logic.

15. The photodetection element according to claim 14, wherein
the second pixel circuit includes:
a charge-voltage conversion circuit that converts the charges accumulated in the second photoelectric conversion element into a voltage;
a differentiation circuit that generates a differential signal corresponding to a change in the voltage converted by the charge-voltage conversion circuit; and
a quantizer that generates a detection signal of the event on a basis of a result of performing a comparison operation of comparing a signal level of the differential signal with a threshold, and
the quantizer performs the comparison operation only when the first control signal in the first pixel corresponding to the second pixel has the predetermined logic.

16. The photodetection element according to claim 15, further comprising
a threshold control unit that controls a voltage level of the threshold in accordance with at least one of a number of the first pixels in which the event is detected among a plurality of the first pixels and a number of the second pixels in which the event is detected among a plurality of the second pixels.

17. The photodetection element according to claim 14, wherein
the first pixel circuit outputs a first event in which a change from a low state to a high state of an amount of incident light is detected or a second event in which a change from a high state to a low state of an amount of incident light is detected, and
the first control signal generator sets the first control signal to the predetermined logic when the first event or the second event is output from the first pixel circuit.

18. The photodetection element according to claim 14, wherein
the first pixel circuit includes a pixel operation switcher that causes the first control signal generator to output the first control signal of the predetermined logic regardless of whether or not the event is detected in the first pixel circuit, or causes the first control signal generator to output the first control signal of the predetermined logic only when the event is detected in the first pixel circuit.

19. The photodetection element according to claim 6, wherein
each of pixels in the pixel array unit includes, with a pixel group including two or more pixels in the pixel array unit as a unit, a pixel operation switcher to cause any one pixel in the pixel group to be the first pixel and remaining pixels to be the second pixel.

20. An electronic device comprising:
a photodetection element that outputs image data; and
a recording unit that records the image data, wherein
the photodetection element includes:
a first pixel region including a plurality of first pixels each performing detection of an event based on an amount of change of an amount of incident light; and
a second pixel region disposed in a vicinity of the first pixel region and including a second pixel that performs detection of the event around a first pixel in which the event is detected among the plurality of first pixels.
